(19) United States
(12) Patent Application Publication
(10) Pub. No.: US 2023/0337725 A1
(43) Pub. Date: Oct. 26, 2023

(54) COMPONENT FOR USE IN AN AEROSOL PROVISION SYSTEM

(71) Applicant: Nicoventures Trading Limited, London (GB)

(72) Inventor: Steven HOLFORD, London (GB)

(21) Appl. No.: 17/757,807

(22) PCT Filed: Dec. 18, 2020
(86) PCT No.: PCT/GB2020/053306

§ 371 Date: Jun. 21, 2022

(30) Foreign Application Priority Data
Dec. 20, 2019 (GB) 1919078.4

(51) Int. Cl. A24D 1/20; A24F 40/48; A24D 3/04; A24D 3/18

(52) U.S. Cl. CPC A24D 1/20; A24F 40/48; A24D 3/043; A24D 3/18

(57) ABSTRACT

A component for use in a non-combustible aerosol provision system has an inner channel, at least one outer channel and at least one ventilation area arranged to allow external air to flow into the at least one outer channel. There is also provided an article for use with a non-combustible aerosol provision device, the article including an aerosol generating material comprising at least one aerosol forming material and a component. A method of manufacture is also provided.

### PRIORITY CLAIM

The present application is a National Phase entry of PCT Application No. PCT/GB2020/053306, filed Dec. 18, 2020, which claims priority from Great Britain Application No. 1919078.4, filed Dec. 20, 2019, each of which is hereby fully incorporated herein by reference.

### TECHNICAL FIELD

The following relates to a component for use in a non-combustible aerosol provision system, an article for use with a non-combustible aerosol provision device, and a method of manufacturing a component for use in a non-combustible aerosol provision system.

### BACKGROUND

Certain tobacco industry products produce an aerosol during use, which is inhaled by a user. For example, tobacco heating devices heat an aerosol generating substrate such as tobacco to form an aerosol by heating, but not burning, the substrate. Such tobacco industry products can include mouthpieces through which the aerosol passes to reach the user's mouth.

### SUMMARY

In some embodiments described herein, in a first aspect there is provided a component for use in a non-combustible aerosol provision system, the component comprising: an inner channel; at least one outer channel; and at least one ventilation area arranged to allow external air to flow into the at least one outer channel.

In some embodiments described herein, in a second aspect there is provided an article for use with a non-combustible aerosol provision device, the article comprising: an aerosol generating material comprising at least one aerosol forming material; and a component according to the first aspect.

In some embodiments described herein, in a third aspect there is provided a method of manufacturing a component for use in a non-combustible aerosol provision system, the method comprising: forming an inner channel; forming at least one outer channel; and forming at least one ventilation area arranged to allow external air to flow into the at least one outer channel.

In some embodiments described herein, there is provided a non-combustible aerosol provision system, comprising an article according to the second aspect above, and a non-combustible aerosol provision device.

### BRIEF DESCRIPTION OF THE DRAWINGS

Embodiments of the disclosure will now be described, by way of example only, with reference to the accompanying drawings, in which:

FIG. 1a is an end-on view of a component for use in a non-combustible aerosol provision system;

FIG. 1b is a side-on cross sectional view of the component shown in FIG. 1a;

FIG. 1c is a side-on cross sectional view of a further component for use in a non-combustible aerosol provision system;

FIG. 2 is an end-on view of another component for use in a non-combustible aerosol provision system;

FIG. 3 is an end-on view of another component for use in a non-combustible aerosol provision system;

FIG. 4 is an end-on view of another component for use in a non-combustible aerosol provision system;

FIG. 5 is an end-on view of another component for use in a non-combustible aerosol provision system;

FIG. 6 is a side view of an article for use with a non-combustible aerosol provision device, the article including the component shown in FIGS. 1a and 1b;

FIG. 7 is a perspective illustration of a non-combustible aerosol provision device for generating aerosol from the aerosol generating material of the articles of FIG. 6;

FIG. 8 illustrates the device of FIG. 7 with the outer cover removed and without an article present;

FIG. 9 is a side view of the device of FIG. 7 in partial cross-section;

FIG. 10 is an exploded view of the device of FIG. 5, with the outer cover omitted;

FIG. 11A is a cross sectional view of a portion of the device of FIG. 7;

FIG. 11B is a close-up illustration of a region of the device of FIG. 11A; and

And

FIG. 12 is a flow chart showing a method of manufacturing a component for use in a non-combustible aerosol provision system.

### DETAILED DESCRIPTION OF THE DRAWINGS

As used herein, the term “delivery system” is intended to encompass systems that deliver at least one substance to a user, and includes:
combustible aerosol provision systems, such as cigarettes, cigarillos, cigars, and tobacco for pipes or for roll-your-own or for make-your-own cigarettes (whether based on tobacco, tobacco derivatives, expanded tobacco, reconstituted tobacco, tobacco substitutes or other smokable material);
non-combustible aerosol provision systems that release compounds from an aerosol-generating material without combusting the aerosol-generating material, such as electronic cigarettes, tobacco heating products, and hybrid systems to generate aerosol using a combination of aerosol-generating materials; and
aerosol-free delivery systems that deliver the at least one substance to a user orally, nasally, transdermally or in another way without forming an aerosol, including but not limited to, lozenges, gums, patches, articles comprising inhalable powders, and oral products such as oral tobacco which includes snus or moist snuff, wherein the at least one substance may or may not comprise nicotine.

According to the present disclosure, a “combustible” aerosol provision system is one where a constituent aerosol-generating material of the aerosol provision system (or component thereof) is combusted or burned during use in order to facilitate delivery of at least one substance to a user.

According to the present disclosure, a “non-combustible” aerosol provision system is one where a constituent aerosol-generating material of the aerosol provision system (or component thereof) is not combusted or burned in order to facilitate delivery of at least one substance to a user.

In embodiments described herein, the delivery system is a non-combustible aerosol provision system, such as a powered non-combustible aerosol provision system.

In some embodiments, the non-combustible aerosol provision system is an electronic cigarette, also known as a vaping device or electronic nicotine delivery system (END), although it is noted that the presence of nicotine in the aerosol-generating material is not a requirement.

In some embodiments, the non-combustible aerosol provision system is an aerosol-generating material heating system, also known as a heat-not-burn system. An example of such a system is a tobacco heating system.

In one embodiment, the non-combustible aerosol provision system is a hybrid system to generate aerosol using a combination of aerosolizable materials, one or a plurality of which may be heated. Each of the aerosolizable materials may be, for example, in the form of a solid, liquid or gel and may or may not contain nicotine. In one embodiment, the hybrid system comprises a liquid or gel aerosolizable material and a solid aerosolizable material. The solid aerosolizable material may comprise, for example, tobacco or a non-tobacco product.

Typically, the non-combustible aerosol provision system may comprise a non-combustible aerosol provision device and a consumable for use with the non-combustible aerosol provision device.

In some embodiments, the disclosure relates to consumables comprising aerosol-generating material and configured to be used with non-combustible aerosol provision devices. These consumables are sometimes referred to as articles throughout the disclosure.

A consumable is an article comprising or consisting of aerosol-generating material, part or all of which is intended to be consumed during use by a user. A consumable may comprise one or more other components, such as an aerosol-generating material storage area, an aerosol-generating material transfer component, an aerosol generation area, a housing, a wrapper, a mouthpiece, a filter and/or an aerosol-modifying agent. A consumable may also comprise an aerosol generator, such as a heater, that emits heat to cause the aerosol-generating material to generate aerosol in use. The heater may, for example, comprise combustible material, a material heatable by electrical conduction, or a susceptor.

In some embodiments, the non-combustible aerosol provision system, such as a non-combustible aerosol provision device thereof, may comprise a power source and a controller. The power source may, for example, be an electric power source or an exothermic power source. In some embodiments, the exothermic power source comprises a carbon substrate which may be energized so as to distribute power in the form of heat to an aerosol-generating material or to a heat transfer material in proximity to the exothermic power source.

In some embodiments, the non-combustible aerosol provision system may comprise an area for receiving the consumable, an aerosol generator, an aerosol generation area, a housing, a mouthpiece, a filter and/or an aerosol-modifying agent.

In some embodiments, the consumable for use with the non-combustible aerosol provision device may comprise aerosol-generating material, an aerosol-generating material storage area, an aerosol-generating material transfer component, an aerosol generator, an aerosol generation area, a housing, a wrapper, a filter, a mouthpiece, and/or an aerosol-modifying agent.

In some embodiments, the substance to be delivered may be an aerosol-generating material or a material that is not intended to be aerosolized. As appropriate, either material may comprise one or more active constituents, one or more flavors, one or more aerosol-former materials, and/or one or more other functional materials.

An aerosol generator is an apparatus configured to cause aerosol to be generated from the aerosol-generating material. In some embodiments, the aerosol generator is a heater configured to subject the aerosol-generating material to heat energy, so as to release one or more volatiles from the aerosol-generating material to form an aerosol. In some embodiments, the aerosol generator is configured to cause an aerosol to be generated from the aerosol-generating material without heating. For example, the aerosol generator may be configured to subject the aerosol-generating material to one or more of vibration, increased pressure, or electrostatic energy.

Aerosol-generating material is a material that is capable of generating aerosol, for example when heated, irradiated or energized in any other way. Aerosol-generating material may, for example, be in the form of a solid, liquid or gel which may or may not contain an active substance and/or flavorants. In some embodiments, the aerosol-generating material may comprise an “amorphous solid”, which may alternatively be referred to as a “monolithic solid” (i.e. non-fibrous). In some embodiments, the amorphous solid may be a dried gel. The amorphous solid is a solid material that may retain some fluid, such as liquid, within it. In some embodiments, the aerosol-generating material may for example comprise from about 50 wt %, 60 wt % or 70 wt % of amorphous solid, to about 90 wt %, 95 wt % or 100 wt % of amorphous solid.

The aerosol-generating material may comprise one or more active substances and/or flavors, one or more aerosol-former materials, and optionally one or more other functional material.

The aerosol-former material may comprise one or more constituents capable of forming an aerosol. In some embodiments, the aerosol-former material may comprise one or more of glycerine, glycerol, propylene glycol, diethylene glycol, triethylene glycol, tetraethylene glycol, 1,3-butylene glycol, erythritol, meso-Erythritol, ethyl vanillate, ethyl laurate, a diethyl suberate, triethyl citrate, triacetin, a diacetin mixture, benzyl benzoate, benzyl phenyl acetate, tributyrin, lauryl acetate, lauric acid, myristic acid, and propylene carbonate.

The one or more other functional materials may comprise one or more of pH regulators, coloring agents, preservatives, binders, fillers, stabilizers, and/or antioxidants.

The material may be present on or in a support, to form a substrate. The support may, for example, be or comprise paper, card, paperboard, cardboard, reconstituted material, a plastics material, a ceramic material, a composite material, glass, a metal, or a metal alloy. In some embodiments, the support comprises a susceptor. In some embodiments, the susceptor is embedded within the material. In some alternative embodiments, the susceptor is on one or either side of the material.

An aerosol-modifying agent is a substance, typically located downstream of the aerosol generation area, that is configured to modify the aerosol generated, for example by changing the taste, flavor, acidity or another characteristic of the aerosol. The aerosol-modifying agent may be provided in an aerosol-modifying agent release component that is operable to selectively release the aerosol-modifying agent.

The aerosol-modifying agent may, for example, be an additive or a sorbent. The aerosol-modifying agent may, for example, comprise one or more of a flavorant, a colorant, water, and a carbon adsorbent. The aerosol-modifying agent may, for example, be a solid, a liquid, or a gel. The aerosol-modifying agent may be in powder, thread or granule form. The aerosol-modifying agent may be free from filtration material.

A susceptor is a material that is heatable by penetration with a varying magnetic field, such as an alternating magnetic field. The susceptor may be an electrically-conductive material, so that penetration thereof with a varying magnetic field causes induction heating of the heating material. The heating material may be magnetic material, so that penetration thereof with a varying magnetic field causes magnetic hysteresis heating of the heating material. The susceptor may be both electrically-conductive and magnetic, so that the susceptor is heatable by both heating mechanisms. The device that is configured to generate the varying magnetic field is referred to as a magnetic field generator, herein.

Induction heating is a process in which an electrically-conductive object is heated by penetrating the object with a varying magnetic field. The process is described by Faraday's law of induction and Ohm's law. An induction heater may comprise an electromagnet and a device for passing a varying electrical current, such as an alternating current, through the electromagnet. When the electromagnet and the object to be heated are suitably relatively positioned so that the resultant varying magnetic field produced by the electromagnet penetrates the object, one or more eddy currents are generated inside the object. The object has a resistance to the flow of electrical currents. Therefore, when such eddy currents are generated in the object, their flow against the electrical resistance of the object causes the object to be heated. This process is called Joule, ohmic, or resistive heating. An object that is capable of being inductively heated is known as a susceptor.

In one embodiment, the susceptor is in the form of a closed circuit. It has been found that, when the susceptor is in the form of a closed circuit, magnetic coupling between the susceptor and the electromagnet in use is enhanced, which results in greater or improved Joule heating.

Magnetic hysteresis heating is a process in which an object made of a magnetic material is heated by penetrating the object with a varying magnetic field. A magnetic material can be considered to comprise many atomic-scale magnets, or magnetic dipoles. When a magnetic field penetrates such material, the magnetic dipoles align with the magnetic field. Therefore, when a varying magnetic field, such as an alternating magnetic field, for example as produced by an electromagnet, penetrates the magnetic material, the orientation of the magnetic dipoles changes with the varying applied magnetic field. Such magnetic dipole reorientation causes heat to be generated in the magnetic material.

When an object is both electrically-conductive and magnetic, penetrating the object with a varying magnetic field can cause both Joule heating and magnetic hysteresis heating in the object. Moreover, the use of magnetic material can strengthen the magnetic field, which can intensify the Joule heating.

In each of the above processes, as heat is generated inside the object itself, rather than by an external heat source by heat conduction, a rapid temperature rise in the object and more uniform heat distribution can be achieved, particularly through selection of suitable object material and geometry, and suitable varying magnetic field magnitude and orientation relative to the object. Moreover, as induction heating and magnetic hysteresis heating do not require a physical connection to be provided between the source of the varying magnetic field and the object, design freedom and control over the heating profile may be greater, and cost may be lower.

Articles, for instance those in the shape of rods, are often named according to the product length: “regular” (typically in the range 68-75 mm, e.g. from about 68 mm to about 72 mm), “short” or “mini” (68 mm or less), “king-size” (typically in the range 75-91 mm, e.g. from about 79 mm to about 88 mm), “long” or “super-king” (typically in the range 91-105 mm, e.g. from about 94 mm to about 101 mm) and “ultra-long” (typically in the range from about 110 mm to about 121 mm).

They are also named according to the product circumference: “regular” (about 23-25 mm), “wide” (greater than 25 mm), “slim” (about 22-23 mm), “demi-slim” (about 19-22 mm), “super-slim” (about 16-19 mm), and “micro-slim” (less than about 16 mm).

Accordingly, an article in a king-size, super-slim format will, for example, have a length of about 83 mm and a circumference of about 17 mm.

Each format may be produced with mouthpieces of different lengths. The mouthpiece length will be from about 30 mm to 50 mm. A tipping paper connects the mouthpiece to the aerosol generating material and will usually have a greater length than the mouthpiece, for example from 3 to 10 mm longer, such that the tipping paper covers the mouthpiece and overlaps the aerosol generating material, for instance in the form of a rod of substrate material, to connect the mouthpiece to the rod.

Articles and their aerosol generating materials and mouthpieces described herein can be made in, but are not limited to, any of the above formats.

The terms ‘upstream’ and ‘downstream’ used herein are relative terms defined in relation to the direction of mainstream aerosol drawn though an article or device in use.

The filamentary tow or filter material described herein can comprise cellulose acetate fiber tow. The filamentary tow can also be formed using other materials used to form fibers, such as polyvinyl alcohol (PVOH), polylactic acid (PLA), polycaprolactone (PCL), poly(1-4 butanediol succinate) (PBS), poly(butylene adipate-co-terephthalate)(PBAT), starch based materials, cotton, aliphatic polyester materials and polysaccharide polymers or a combination thereof. The filamentary tow may be plasticized with a suitable plasticizer for the tow, such as triacetin where the material is cellulose acetate tow, or the tow may be non-plasticized. The tow can have any suitable specification, such as fibers having a cross section which is ‘Y’ shaped, ‘X’ shaped or ‘O’ shaped. The fibers of the tow may have filamentary denier values between 2.5 and 15 denier per filament, for example between 8.0 and 11.0 denier per filament and total denier values of 5,000 to 50,000, for example between 10,000 and 40,000. The cross section of the fibers may have an isoperimetric ratio L²/A of 25 or less, 20 or less, or 15 or less, where L is the length of the perimeter of the cross section and A is the area of the cross section. Such fibers have a relatively low surface area for a given value of denier per filament, which improves delivery of aerosol to the consumer. Filter material described herein also includes cellulose-based materials such as paper. Such materials may have a relatively low density, such as between about 0.1 and about 0.45 grams per cubic centimeter, to allow air and/or aerosol to pass through the material. Although described as filter materials, such materials may have a primary purpose, such as increasing the resistance to draw of a component that is not related to filtration as such.

As used herein, the term “tobacco material” refers to any material comprising tobacco or derivatives or substitutes thereof. The term “tobacco material” may include one or more of tobacco, tobacco derivatives, expanded tobacco, reconstituted tobacco or tobacco substitutes. The tobacco material may comprise one or more of ground tobacco, tobacco fiber, cut tobacco, extruded tobacco, tobacco stem, tobacco lamina, reconstituted tobacco and/or tobacco extract.

In some embodiments, the substance to be delivered comprises an active substance.

The active substance as used herein may be a physiologically active material, which is a material intended to achieve or enhance a physiological response. The active substance may for example be selected from nutraceuticals, nootropics, psychoactives. The active substance may be naturally occurring or synthetically obtained. The active substance may comprise for example nicotine, caffeine, taurine, theine, vitamins such as B6 or B12 or C, melatonin, cannabinoids, or constituents, derivatives, or combinations thereof. The active substance may comprise one or more constituents, derivatives or extracts of tobacco or another botanical.

In some embodiments, the active substance comprises nicotine. In some embodiments, the active substance comprises caffeine, melatonin or vitamin B12.

As noted herein, the active substance may comprise or be derived from one or more botanicals or constituents, derivatives or extracts thereof. As used herein, the term “botanical” includes any material derived from plants including, but not limited to, extracts, leaves, bark, fibers, stems, roots, seeds, flowers, fruits, pollen, husk, shells or the like. Alternatively, the material may comprise an active compound naturally existing in a botanical, obtained synthetically. The material may be in the form of liquid, gas, solid, powder, dust, crushed particles, granules, pellets, shreds, strips, sheets, or the like. Example botanicals are tobacco, eucalyptus, star anise, hemp, cocoa, cannabis, fennel, lemongrass, peppermint, spearmint, rooibos, chamomile, flax, ginger, Ginkgo biloba, hazel, hibiscus, laurel, licorice (liquorice), matcha, mate, orange skin, papaya, rose, sage, tea such as green tea or black tea, thyme, clove, cinnamon, coffee, aniseed (anise), basil, bay leaves, cardamom, coriander, cumin, nutmeg, oregano, paprika, rosemary, saffron, lavender, lemon peel, mint, juniper, elderflower, vanilla, wintergreen, beefsteak plant, curcuma, turmeric, sandalwood, cilantro, bergamot, orange blossom, myrtle, cassis, valerian, pimento, mace, damien, marjoram, olive, lemon balm, lemon basil, chive, carvi, verbena, tarragon, geranium, mulberry, ginseng, theanine, theacrine, maca, ashwagandha, damiana, guarana, chlorophyll, baobab or any combination thereof. The mint may be chosen from the following mint varieties: Mentha Arventis, Mentha c.v., Mentha niliaca, Mentha piperita, Mentha piperita citrata c.v., Mentha piperita c.v, Mentha spicata crispa, Mentha cardifolia, Memtha longifolia, Mentha suaveolens variegata, Mentha pulegium, Mentha spicata c.v. and Mentha suaveolens

In some embodiments, the active substance comprises or is derived from one or more botanicals or constituents, derivatives or extracts thereof and the botanical is tobacco.

In some embodiments, the active substance comprises or derived from one or more botanicals or constituents, derivatives or extracts thereof and the botanical is selected from eucalyptus, star anise, cocoa and hemp.

In some embodiments, the active substance comprises or derived from one or more botanicals or constituents, derivatives or extracts thereof and the botanical is selected from rooibos and fennel.

In some embodiments, the substance to be delivered comprises a flavor.

As used herein, the terms “flavor” and “flavorant” refer to materials which, where local regulations permit, may be used to create a desired taste, aroma or other somatosensorial sensation in a product for adult consumers. They may include naturally occurring flavor materials, botanicals, extracts of botanicals, synthetically obtained materials, or combinations thereof (e.g., tobacco, cannabis, licorice (liquorice), hydrangea, eugenol, Japanese white bark magnolia leaf, chamomile, fenugreek, clove, maple, matcha, menthol, Japanese mint, aniseed (anise), cinnamon, turmeric, Indian spices, Asian spices, herb, wintergreen, cherry, berry, red berry, cranberry, peach, apple, orange, mango, clementine, lemon, lime, tropical fruit, papaya, rhubarb, grape, durian, dragon fruit, cucumber, blueberry, mulberry, citrus fruits, Drambuie, bourbon, scotch, whiskey, gin, tequila, rum, spearmint, peppermint, lavender, aloe vera, cardamom, celery, cascarilla, nutmeg, sandalwood, bergamot, geranium, khat, naswar, betel, shisha, pine, honey essence, rose oil, vanilla, lemon oil, orange oil, orange blossom, cherry blossom, cassia, caraway, cognac, jasmine, ylang-ylang, sage, fennel, wasabi, piment, ginger, coriander, coffee, hemp, a mint oil from any species of the genus Mentha, eucalyptus, star anise, cocoa, lemongrass, rooibos, flax, Ginkgo biloba, hazel, hibiscus, laurel, mate, orange skin, rose, tea such as green tea or black tea, thyme, juniper, elderflower, basil, bay leaves, cumin, oregano, paprika, rosemary, saffron, lemon peel, mint, beefsteak plant, curcuma, cilantro, myrtle, cassis, valerian, pimento, mace, damien, marjoram, olive, lemon balm, lemon basil, chive, carvi, verbena, tarragon, limonene, thymol, camphene), flavor enhancers, bitterness receptor site blockers, sensorial receptor site activators or stimulators, sugars and/or sugar substitutes (e.g., sucralose, acesulfame potassium, aspartame, saccharine, cyclamates, lactose, sucrose, glucose, fructose, sorbitol, or mannitol), and other additives such as charcoal, chlorophyll, minerals, botanicals, or breath freshening agents. They may be imitation, synthetic or natural ingredients or blends thereof. They may be in any suitable form, for example, liquid such as an oil, solid such as a powder, or gas.

In some embodiments, the flavor comprises menthol, spearmint and/or peppermint. In some embodiments, the flavor comprises flavor components of cucumber, blueberry, citrus fruits and/or redberry. In some embodiments, the flavor comprises eugenol. In some embodiments, the flavor comprises flavor components extracted from tobacco. In some embodiments, the flavor comprises flavor components extracted from cannabis.

In some embodiments, the flavor may comprise a sensate, which is intended to achieve a somatosensorial sensation which are usually chemically induced and perceived by the stimulation of the fifth cranial nerve (trigeminal nerve), in addition to or in place of aroma or taste nerves, and these may include agents providing heating, cooling, tingling, numbing effect. A suitable heat effect agent may be, but is not limited to, vanillyl ethyl ether and a suitable cooling agent may be, but not limited to eucolyptol, WS-3.

In the figures described herein, like reference numerals are used to illustrate equivalent features, articles or components.

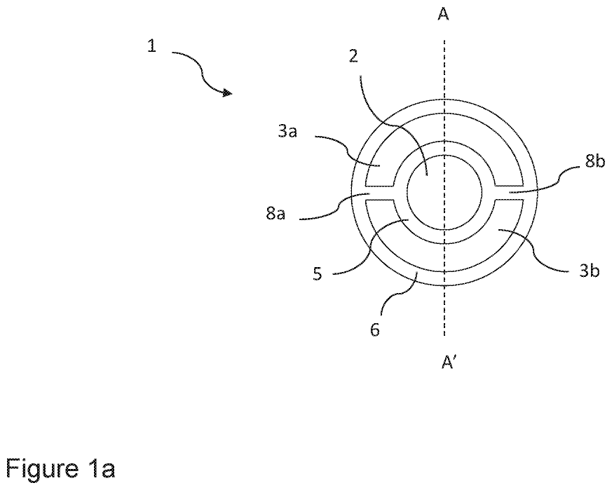

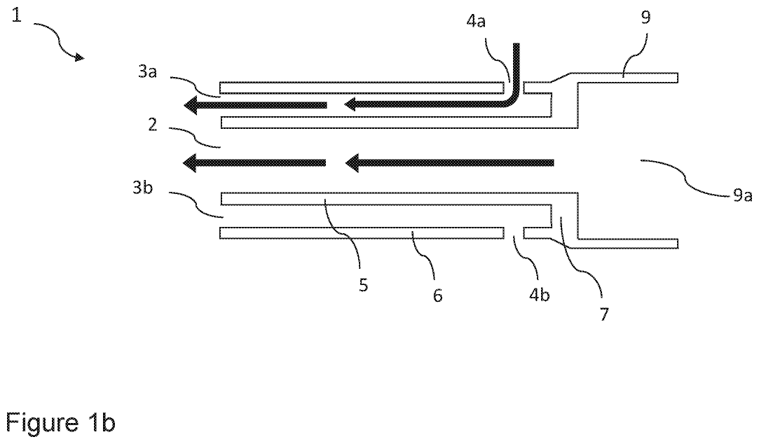

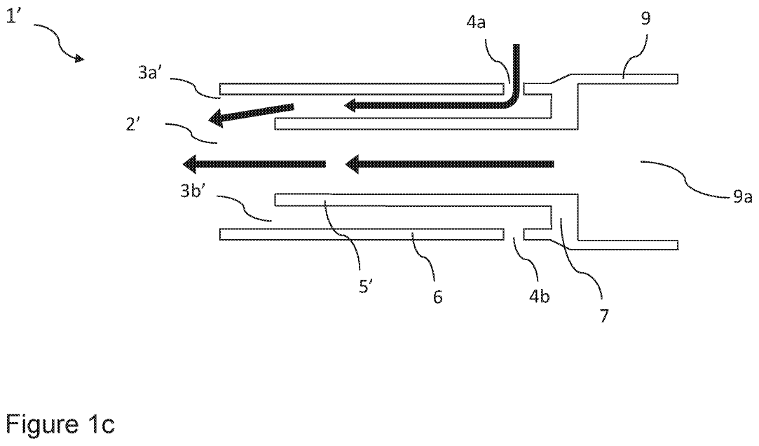

FIG. 1a is an end-on view of a component for use in a non-combustible aerosol provision system. In the present example, and other examples described herein, the component is a component of a non-combustible aerosol provision system, for example a component of a tobacco heated product. FIG. 1b is a side-on cross sectional view of the component shown in FIG. 1a through the line A-A′.

In the present example, the component 1 includes an inner channel 2, outer channels 3a, 3b, and ventilation areas 4a, 4b. The first ventilation area 4a is arranged to allow external air to flow into the first outer channel 3a, and the second ventilation area 4b is arranged to allow external air to flow into the second outer channel 3b.

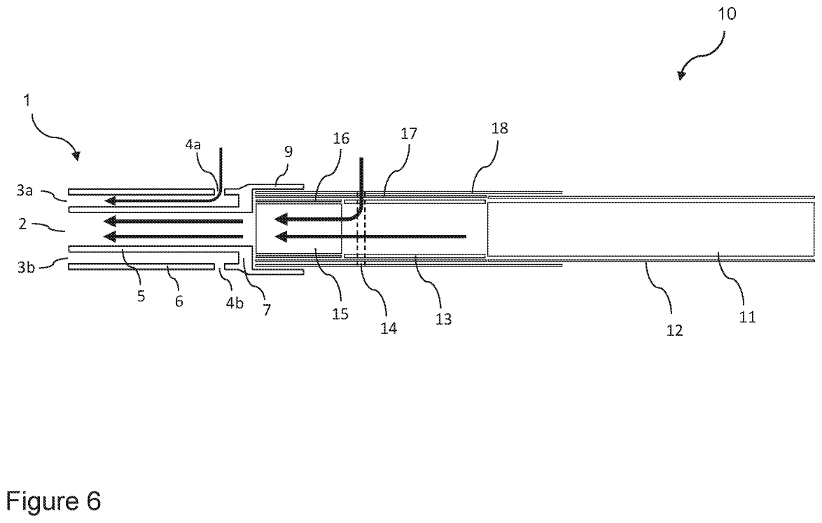

In some examples, the component 1 may be a mouthpiece for an article which is to be used with a non-combustible aerosol provision device. This is explained in more detail below in relation to FIG. 6.

In the present example, the component 1 is formed from a plastic material. The inner channel 2 and the outer channels 3a, 3b may be formed by an injection molding process.

The inner channel 2 is arranged to channel aerosol generated by the non-combustible aerosol provision system. The inner channel 2 is substantially cylindrical in shape, and extends along a longitudinal axis of the component 1 (not shown). The outer channels 3a, 3b extend parallel to the longitudinal axis of the component 1. In other words, the inner channel 2 and the outer channels 3a, 3b are parallel to each other.

The inner channel 2 and outer channels 3a, 3b have downstream ends at the downstream end of the component 2. This significantly reduces or substantially prevents mixing of the flow through the inner channel 2 and outer channels 3a, 3b before the flow reaches a consumer's mouth. The can reduce the formation of visible aerosol, which can be desirable.

When viewed end-on as in FIG. 1a, the first outer channel 3a and the second outer channel 3b each extend around part of the circumference of the inner channel 2, so as to surround the inner channel 2. First and second walls 8a, 8b separate the two outer channels 3a, 3b. The first and second walls 8a, 8b extend parallel to the longitudinal axis of the component 1.

In the present example, the inner channel 2 has a diameter of 2.68 mm. In some examples, the inner channel may have a diameter in the range 2 mm to 5 mm, for example 3 mm or 4 mm.

In the present example, the inner channel 2 has a length of 16 mm. In some examples, the inner channel may have a length in the range 12 mm to 20 mm.

The component 1 has a mouth end and a distal end. The inner channel 2 and the outer channels 3a, 3b are open at the mouth end. In use, this allows aerosol from the inner channel 2 and/or air from the outer channels 3a, 3b to flow out of the mouth end of the component 1, as shown in FIG. 1b.

The component 1 comprises an inner wall 5 which separates the inner channel 2 from the first and second outer channels 3a, 3b. The inner wall 5 is substantially impermeable to air. This prevents aerosol flowing in the inner channel 2 and air flowing in the outer channels 3a, 3b from mixing within the component 1. In the present example, the inner wall 5 has a thickness of 1 mm. In some examples, the inner wall may have a thickness in the range 0.8 mm to 2 mm.

The component 1 also comprises an outer wall 6. The outer wall 6 is disposed radially outwards from the inner wall 5 when the component 1 is viewed end on, as shown in FIG. 1a. In the present example, the outer wall 6 defines part of the outer surface of the component 1, and has a circumference of 21 mm. In the present example, the outer wall 6 has a thickness of 1 mm. In some examples, the outer wall may have a thickness in the range 0.8 mm to 2 mm.

First and second ventilation apertures 4a, 4b are formed in the outer wall 6. The first ventilation aperture 4a extends through the outer wall 6 so as to allow external air to flow into the first outer channel 3a, and the second ventilation aperture 4b extends through the outer wall 6 so as to allow external air to flow into the second outer channel 3a. In the present example, a single ventilation aperture is formed for each outer channel. In some examples, multiple ventilation apertures may be formed for each outer channel. For example, there may be 2 to 10 ventilation apertures for each outer channel.

In the present example, the minimum distance between the mouth end of the component 1 and the ventilation apertures 4a, 4b is 12 mm. In some examples, the minimum distance between the mouth end of the component 1 and the ventilation apertures may be in the range 10 mm to 16 mm.

An end wall 7 connects the distal ends of the inner wall 5 and the outer wall 6. The end wall 7 defines the distal ends of the outer channels 3a, 3b. In the present example, the first and second outer channels 3a, 3b each have a length of 14 mm. In other examples, the outer channels may have a length in the range 10 mm to 18 mm, or in the range 12 mm to 16 mm.

The ratio of the total cross sectional area of the outer channels to the cross sectional area of the inner channel may be adjusted to control the amount of external air flow relative to the amount of aerosol delivered to the user. The ratio of the total cross sectional area of the outer channels to the cross sectional area of the inner channel may be in the range 5:1 to 0.5:1. In the present example, the ratio of the total cross sectional area of the outer channels 3a, 3b to the cross sectional area of the inner channel 2 is approximately 3:1.

In the present example, the component 1 comprises an opening 9a at the distal end of the component 1. The opening 9a is defined by a distal end wall 9 which is connected to the end wall 7. The opening 9a and the inner channel 2 form a continuous channel within the component 1 so that, in use, aerosol can flow into the component 1 through the opening 9a and into the inner channel 2.

The distal end wall 9 forms a part of the outer surface of the component 1. In the present example, the distal end wall 9 has an outer circumference of approximately 25 mm, and a thickness of 1.32 mm. In some examples, the distal end wall may have a diameter in the range 6 mm to 10 mm, and may have a thickness in the range 1 mm to 3 mm, for example 2 mm.

The opening 9a is arranged to receive a rod-shaped article. This allows the component 1 to be integrated in an article for use with a non-combustible aerosol provision device, as shown in FIG. 6. In the present example, the opening 9a is circular in cross section and has a diameter of 6.68 mm. In some examples, the opening may have a diameter in the range 5 mm to 10 mm. The size of the opening can be chosen based on the size of the rod-shaped article.

FIG. 1c is a side-on cross sectional view of a further component for use in a non-combustible aerosol provision system.

In the present example, the component 1′ includes an inner channel 2′ and outer channels 3a′, 3b′ that combine into a single, larger channel at the mouth end of the component. Inner wall 5′, which separates the inner channel 2′ from the first and second outer channels 3a′, 3b′, has a downstream end which is spaced at a distance of between lmm and 20 mm, or between 3 mm and 10 mm, from the downstream end of the component 1′, defined by the outer wall 6.

The first ventilation area 4a is arranged to allow external air to flow into the first outer channel 3a′, and the second ventilation area 4b is arranged to allow external air to flow into the second outer channel 3b′, and the external air from these outer channels 3a′, 3b′ is arranged to mix with aerosol flowing through the inner channel 2′ before reaching the downstream end of the component. This mixing can enhance visible aerosol formation.

In other examples, there may be perforations or other openings in the inner wall 5′ which allow air flow from the first and second outer channels 3a′, 3b′ to mix with the aerosol flow through the inner channel 2′ prior to reaching the downstream end of the component 1′.

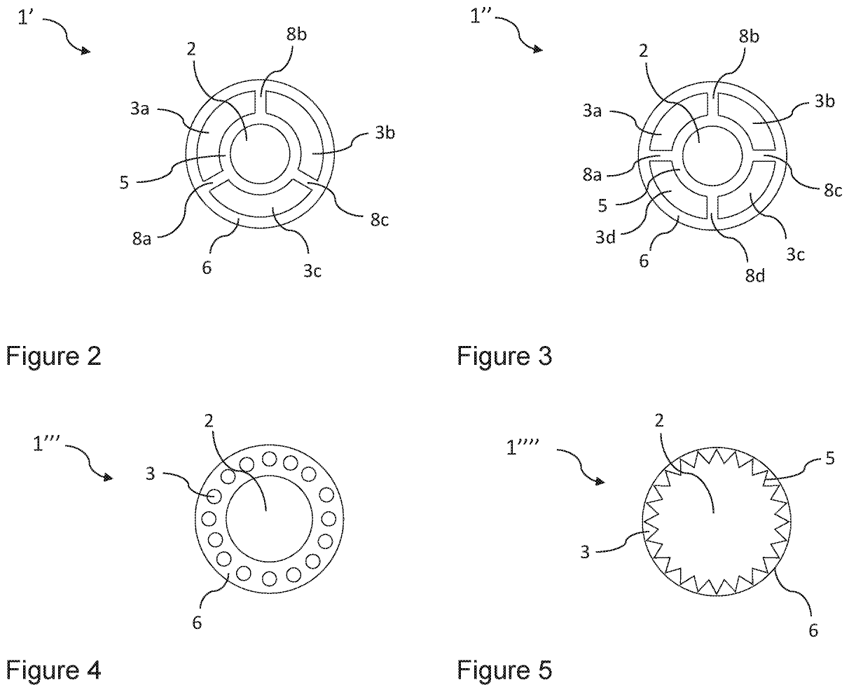

FIG. 2 is an end-on view of another component for use in a non-combustible aerosol provision system.

The component 1′ shown in FIG. 2 is similar to the component 1 shown in FIGS. 1a and 1b, but includes three outer channels 3a, 3b, 3c. Ventilation apertures (not shown) are formed in the outer wall 6 to allow external air to flow into the outer channels 3a, 3b, 3c respectively.

FIG. 3 is an end-on view of another component for use in a non-combustible aerosol provision system.

The component 1″ shown in FIG. 3 is similar to the component shown in FIG. 2, but includes four outer channels 3a, 3b, 3c, 3d. Ventilation apertures (not shown) are formed in the outer wall 6 to allow external air to flow into the outer channels 3a, 3b, 3c, 3d respectively.

FIG. 4 is an end-on view of another component for use in a non-combustible aerosol provision system.

The component 1′″ shown in FIG. 4 includes sixteen outer channels 3. Ventilation apertures (not shown) are formed in the outer wall 6 to allow external air to flow into the outer channels 3.

FIG. 5 is an end-on view of another component for use in a non-combustible aerosol provision system.

The component 1 shown in FIG. 5 includes 24 outer channels 3. The inner wall 5 is corrugated in profile, and defines the inner channel 2. The inner wall 5 also separates the inner channel 2 from the outer channels 3. Both the inner wall 5 and the outer wall 6 are formed from a sheet material, in the present case stiff plug wrap. The sheet material forming the outer wall 6 is wrapped around the sheet material forming the inner wall 5 so as to define the outer channels 3. The sheet material forming the inner and outer walls may have a basis weight of between about 15 and about 65 gsm, between about 20 and about 60 gsm, or between about 24 and about 55 gsm. The inner channel 2 and/or outer channels 3 in the embodiment of FIG. 5 or in any of the embodiments described herein may be empty, or may comprise material, such as fibrous filtration material. The material may, for instance, be cellulose acetate tow, fibrous paper filter material, or another filter material described herein. The density of the material can be between about 0.10 and about 0.55 grams per cubic centimeter, or between about 0.12 and about 0.5 grams per cubic centimeter, including any additives such as plasticizer.

FIG. 6 is a side view of an article for use with a non-combustible aerosol provision device. In the present example, the article includes the component shown in FIGS. 1a and 1b. In other examples, the article may include any of the components shown in FIGS. 2 to 5.

In the present example, the component 1 acts as a mouthpiece of the article 10, and defines the mouth end of the article 10.

The article 10 includes a cylindrical rod of aerosol generating material 11, in the present case tobacco material; a hollow tubular element 13 disposed downstream of the aerosol generating material 11; and a body of material 15 disposed downstream of the tubular element 13.

In the present example, the aerosol generating material 11 is wrapped in a wrapper 12. The wrapper 12 can, for instance, be a paper or paper-backed foil wrapper.

The wrapper 12 may have a high level of permeability, such as greater than about 1000 Coresta Units, greater than about 1500 Coresta Units, or greater than about 2000 Coresta Units. The wrapper 12 may have a maximum permeability of less than about 20000 Coresta Units, or less than about 15000 Coresta Units, or less than about 5000 Coresta Units. The permeability of the wrapper 12 can be measured in accordance with ISO 2965:2009 concerning the determination of air permeability for materials used as cigarette papers, filter plug wrap and filter joining paper.

The wrapper 12 may be formed from a material with a high inherent level of permeability, an inherently porous material, or may be formed from a material with any level of inherent permeability where the final level of permeability is achieved by providing the wrapper 12 with a permeable zone or area. Where wrapper 12 is provided with a permeable zone, the permeable zone may be a discrete area, or the permeable zone may extend over substantially the whole of the wrapper 12. For instance, the wrapper 12 may be provided with discrete bands of ventilation perforations, or the wrapper may be provided with ventilation perforations extending across and around substantially the entire wrapper 12. The wrapper 12 may be provided with ventilation perforations in any configuration to achieve the final level of permeability. The percentage of the surface area of the wrapper which has the level of permeability described herein may be greater than 50%, greater than 75%, greater than 90%, or 100%.

In the present example, ventilation is provided directly into the tubular element 13, via ventilation area 14. In the present example, ventilation area 14 comprises first and second parallel rows of perforations, in the present case formed as laser perforations, at positions 33.925 mm and 54.625 mm respectively from the downstream, mouth-end of the mouthpiece 1. These perforations pass though tipping paper 18, plug wrap 17 and the hollow tubular element 13. In alternative examples, the ventilation can be provided into the article 10 at other locations, for instance into the body of material 15. Alternatively, the ventilation can be provided via a single row of perforations, for instance laser perforations, into the portion of the article in which the hollow tubular element is located. This has been found to result in improved aerosol formation, which is thought to result from the airflow through the perforations being more uniform than with multiple rows of perforations, for a given ventilation level.

In use, when a user draws air through the article 10, air enters the article 10 through the ventilation apertures 4a, 4b formed in the mouthpiece 1. Air also enters the article 10 via ventilation area 14. Aerosol generated by the aerosol generating material 11 mixes with the air drawn into the article 10 via ventilation area 14.

Adjusting the relative amounts of ventilating air entering the article via the ventilation apertures 4a, 4b of the mouthpiece 1 and the ventilation area 14 controls the amount of visible aerosol exiting the mouthpiece 1 in use. In some examples, the ventilation apertures in the mouthpiece are the only ventilation areas in the article, so that the ventilating air exiting the mouthpiece is all drawn through the outer channels of the mouthpiece. This leads to less aerosol being visible in use.

The ventilation area 14 provides a level of ventilation to the article which is less than 50% of the air drawn through the article. In some examples, the article can have a ventilation level of between 50% and 80% of aerosol drawn through the article, for instance between 65% and 75%. Ventilation at these levels helps to slow down the flow of aerosol drawn through the article 10 and thereby enable the aerosol to cool sufficiently before it reaches the downstream end of article 10.

Aerosol temperature has been found to generally increase with a drop in the ventilation level. However the relationship between aerosol temperature and ventilation level does not appear to be linear, with variations in ventilation, for instance due to manufacturing tolerances, having less impact at lower target ventilation levels. For instance, with a ventilation tolerance of ±15%, for a target ventilation level of 75%, the aerosol temperature could increase by approximately 6° C. at the lower ventilation limit (60% ventilation). However, with a target ventilation level of 60% the aerosol temperature may only increase by approximately 3.5° C. at the lower vent limit (45% ventilation). The target ventilation level of the article can therefore be within the range 40% to 70%, for instance, 45% to 65%. The mean ventilation level of at least 20 articles can be between 40% and 70%, for instance between 45% and 70% or between 51% and 59%.

Providing a permeable wrapper 12 provides a route for air to enter the article 10. In some examples, the wrapper 12 can be provided with a permeability such that the amount of air entering the article through the rod of aerosol generating material is relatively more than the amount of air entering the article through the ventilation area 14 in the tubular element 13. An article having this arrangement may produce a more flavorsome aerosol which may be more satisfactory to the user.

The article 10 comprises a cavity having an internal volume greater than 450 mm³. Providing a cavity of at least this volume has been found to enable the formation of an improved aerosol. Such a cavity size provides sufficient space within the article 10 to allow heated volatilized components to cool, therefore allowing the exposure of the aerosol generating material 11 to higher temperatures than would otherwise be possible, since they may result in an aerosol which is too warm.

In the present example, the cavity is formed within the hollow tubular element 13, but in alternative arrangements it could be formed within a different part of the article 10. In some embodiments, the article 10 comprises a cavity, for instance formed within the hollow tubular element 13, having an internal volume greater than 500 mm³, or greater than 550 mm³, allowing further improvement of the aerosol. In some examples, the internal cavity comprises a volume of between about 550 mm³ and about 750 mm³, for instance about 600 mm³ or 700 mm³.

In the present example, the hollow tubular element 13 is upstream of, adjacent to and in an abutting relationship with a body of material 15. The hollow tubular element 13 and body of material 15 each define a substantially cylindrical overall outer shape and share a common longitudinal axis. Together, the hollow tubular element 13 and body of material 15 define a rod-shaped article which is inserted into the opening at the distal end of the mouthpiece 1. The rod-shaped article may be secured within the opening by means of an interference fit, or by an adhesive.

In the present example, the hollow tubular element 13 is formed from a plurality of layers of paper which are parallel wound, with butted seams, to form the tubular element 13. In the present example, first and second paper layers are provided in a two-ply tube, although in other examples 3, 4 or more paper layers can be used forming 3, 4 or more ply tubes. Other constructions can be used, such as spirally wound layers of paper, cardboard tubes, tubes formed using a papier-mâché type process, molded or extruded plastic tubes or similar.

The hollow tubular element 13 can also be formed using a stiff plug wrap and/or tipping paper, for instance as the second plug wrap 17 and/or tipping paper 18 described in more detail below, meaning that a separate tubular element is not required. The stiff plug wrap and/or tipping paper is manufactured to have a rigidity that is sufficient to withstand the axial compressive forces and bending moments that might arise during manufacture and whilst the article 10 is in use. For instance, the stiff plug wrap and/or tipping paper can have a basis weight between 70 gsm and 120 gsm, or between 80 gsm and 110 gsm. Additionally or alternatively, the stiff plug wrap and/or tipping paper can have a thickness between 80 μm and 200 μm, between 100 μm and 160 μm, or from 120 μm to 150 μm. It can be desirable for both the second plug wrap 17 and tipping paper 18 to have values in these ranges, to achieve an acceptable overall level of rigidity for the hollow tubular element 13.

The tubular element 13 can have a wall thickness of at least about 325 μm and up to about 2 mm, between 500 μm and 1.5 mm or between 750 μm and 1 mm. In the present example, the tubular element 13 has a wall thickness of about 1 mm. The “wall thickness” of the tubular element 13 corresponds to the thickness of the wall of the tubular element 13 in a radial direction. This may be measured, for example, using a caliper.

In some embodiments, the thickness of the wall of the tubular element is at least 325 microns or at least 400, 500, 600, 700, 800, 900 or 1000 microns. In some embodiments, the thickness of the wall of the tubular element is at least 1250 or 1500 microns.

In some embodiments, the thickness of the wall of the tubular element is less than 2000 microns or less than 1500 microns.

The increased thickness of the wall of the tubular element means that it has a greater thermal mass, which has been found to help reduce the temperature of the aerosol passing through the tubular element and reduce the surface temperature of the article at locations downstream of the tubular element. This is thought to be because the greater thermal mass of the tubular element allows the tubular element to absorb more heat from the aerosol in comparison to a tubular element with a thinner wall thickness. The increased thickness of the tubular element also channels the aerosol centrally within the article such that less heat from the aerosol is transferred to the outer portions of the article such as outer portions of the body of material.

In some embodiments, the permeability of the material of the wall of the tubular element is at least 100 Coresta Units or at least 500 or 1000 Coresta Units.

It has been found that the relatively high permeability of the tubular element increases the amount of heat that is transferred to the tubular element from the aerosol and thus reduces the temperature of the aerosol. The permeability of the tubular element has also been found to increase the amount of moisture that is transferred from the aerosol to the tubular element, which has been found to improve the feel of the aerosol in the user's mouth. A high permeability of tubular element also makes it easier to cut the ventilation holes using a laser, meaning that a lower power of laser can be used.

The length of the hollow tubular element 13 can be less than about 50 mm. The length of the hollow tubular element 13 can be less than about 40 mm. The length of the hollow tubular element 13 can be less than about 30 mm. In addition, or as an alternative, the length of the hollow tubular element 13 can be at least about 10 mm. The length of the hollow tubular element 13 can be at least about 15 mm. The length of the second hollow tubular element 13 can be from about 20 mm to about 30 mm, from about 22 mm to about 28 mm, from about 24 to about 26 mm, or about 25 mm. In the present example, the length of the hollow tubular element 13 is 25 mm.

The hollow tubular element 13 is located around and defines an air gap within the article which acts as a cooling segment. The air gap provides a chamber through which heated volatilized components generated by the aerosol generating material 11 flow. The hollow tubular element 13 is hollow to provide a chamber for aerosol accumulation yet rigid enough to withstand axial compressive forces and bending moments that might arise during manufacture and whilst the article 10 is in use. The hollow tubular element 13 provides a physical displacement between the aerosol generating material 11 and the body of material 15. The physical displacement provided by the hollow tubular element 13 will provide a thermal gradient across the length of the hollow tubular element 13.

The hollow tubular element 13 can be configured to provide a temperature differential of at least 40 degrees Celsius between a heated volatilized component entering a first, upstream end of the hollow tubular element 13 and a heated volatilized component exiting a second, downstream end of the hollow tubular element 13. The hollow tubular element 13 can be configured to provide a temperature differential of at least 60, 80 or 100 degrees Celsius between a heated volatilized component entering a first, upstream end of the hollow tubular element 13 and a heated volatilized component exiting a second, downstream end of the hollow tubular element 13. This temperature differential across the length of the hollow tubular element 13 protects the temperature sensitive body of material 15 from the high temperatures of the aerosol generating material 11 when it is heated.

In some examples, the aerosol generating material described herein is a first aerosol generating material and the hollow tubular element 13 may include a second aerosol generating material. The wall of the hollow tubular element 13 may comprise the second aerosol generating material. For example, the second aerosol generating material can be disposed on the inner surface of the wall of the hollow tubular element 13.

The second aerosol generating material comprises at least one aerosol former material, and may also comprise at least one aerosol modifying agent, or other sensate material. The aerosol former material and/or aerosol modifying agent can be any aerosol former material or aerosol modifying agent as described herein, or a combination thereof.

As the aerosol generated from aerosol generating material 11, referred to in this case as the first aerosol, is drawn through the hollow tubular element 13 of the article 10, heat from the first aerosol may aerosolize the aerosol forming material of the second aerosol generating material, to form a second aerosol. The second aerosol may comprise a flavorant, which may be additional or complementary to the flavor of the first aerosol.

Providing a second aerosol generating material on the hollow tubular element 13 can result in generation of a second aerosol which boosts or complements the flavor or visual appearance of the first aerosol.

In alternative articles, the hollow tubular element 13 can be replaced with an alternative cooling element, for instance an element formed from a body of material which allows aerosol to pass through it longitudinally, and which also performs the function of cooling the aerosol.

The aerosol generating material 11, also referred to herein as an aerosol generating substrate 11, comprises at least one aerosol forming material. In the present example, the aerosol forming material is glycerol. In alternative examples, the aerosol forming material can be another material as described herein or a combination thereof. The aerosol forming material has been found to improve the sensory performance of the article, by helping to transfer compounds such as flavor compounds from the aerosol generating material to the consumer. However, an issue with adding such aerosol forming materials to the aerosol generating material within an article for use in a non-combustible aerosol provision system can be that, when the aerosol forming material is aerosolized upon heating, it can increase the mass of aerosol which is delivered by the article, and this increased mass can maintain a higher temperature as it passes through the mouthpiece. As it passes through the mouthpiece, the aerosol transfers heat into the mouthpiece and this warms the outer surface of the mouthpiece, including the area which comes into contact with the consumers lips during use. The mouthpiece temperature can be significantly higher than consumers may be accustomed to when smoking, for instance, conventional cigarettes, and this can be an undesirable effect caused by the use of such aerosol forming materials.

The part of the mouthpiece which comes into contact with a consumer's lips has usually been a paper tube, which is either hollow or surrounds a cylindrical body of filter material.

As shown in FIG. 6, the mouthpiece 1 of the article 10 comprises an upstream end adjacent to the body of material 15 and a downstream end (i.e. the mouth end) which is distal from the aerosol generating substrate 11. In use, the external air channeled by the outer channels 3a, 3b of the mouthpiece 1 provides a cool air curtain around the hot aerosol passing through the inner channel 2, thereby reducing heat transfer to the user's lips.

In the present example, the article 10 has an outer circumference of about 21 mm (i.e. the article is in the demi-slim format). In other examples, the article can be provided in any of the formats described herein, for instance having an outer circumference of between 15 mm and 25 mm. Since the article is to be heated to release an aerosol, improved heating efficiency can be achieved using articles having lower outer circumferences within this range, for instance circumferences of less than 23 mm. To achieve improved aerosol via heating, while maintaining a suitable product length, article circumferences of greater than 19 mm have also been found to be particularly effective. Articles having circumferences of between 19 mm and 23 mm, or between 20 mm and 22 mm, have been found to provide a good balance between providing effective aerosol delivery while allowing for efficient heating.

A tipping paper 18 is wrapped around the body of material 15, the tubular element 13 and over at least part of the rod of aerosol generating material 11. The outer circumference of the outer wall 6 of the mouthpiece 1 is substantially the same as the outer circumference of the wrapped rod of aerosol generating material 11. The tipping paper 18 has an adhesive on its inner surface to connect the body of material 15, the tubular element 13 and the rod of aerosol generating material 11. In the present example, the tipping paper 18 extends 5 mm over the rod of aerosol generating material 11 but it can alternatively extend between 3 mm and 10 mm over the rod 11, or between 4 mm and 6 mm, to provide a secure attachment between the body of material 15, the tubular element 13 and the rod of aerosol generating material 11.

The tipping paper 18, also referred to herein as a wrapper, can have a basis weight which is higher than the basis weight of plug wraps used in the article 10, for instance a basis weight of gsm to 80 gsm, between 50 gsm and 70 gsm, and in the present example 58 gsm. These ranges of basis weights have been found to result in tipping papers having acceptable tensile strength while being flexible enough to wrap around the article 10 and adhere to itself along a longitudinal lap seam on the paper. The outer circumference of the tipping paper 18, once wrapped around the aerosol generating material 20, is about 21 mm.

In some examples, the tipping paper comprises citrate, such as sodium citrate and/or potassium citrate. In such examples, the tipping paper may have a citrate content of 2% by weight or less, or 1% by weight or less. Reducing the citrate content of the wrapper can assist with reducing any visible discoloration of the wrapper during use.

In the present example, the article 10 includes a body of material 15. The body of material 15 is wrapped in a first plug wrap 16. The first plug wrap 16 can have a basis weight of less than 50 gsm, or between about 20 gsm and 40 gsm. The first plug wrap 16 can have a thickness of between 30 μm and 60 μm, or between 35 μm and 45 μm. The first plug wrap 16 can be a non-porous plug wrap, for instance having a permeability of less than 100 Coresta units, for instance less than 50 Coresta units. However, in other embodiments, the first plug wrap 16 can be a porous plug wrap, for instance having a permeability of greater than 200 Coresta units.

The length of the body of material 15 can be less than about 15 mm. The length of the body of material 15 can be less than about 10 mm. In addition, or as an alternative, the length of the body of material 15 is at least about 5 mm. The length of the body of material 15 can be at least about 6 mm. In some embodiments, the length of the body of material 15 is from about 5 mm to about 15 mm, from about 6 mm to about 12 mm, from about 6 mm to about 12 mm, or about 6 mm, 7 mm, 8 mm, 9 mm or 10 mm. In the present example, the length of the body of material 15 is 10 mm.

In the present example, the body of material 15 is formed from filamentary tow. In the present example, the tow used in the body of material 15 has a denier per filament (d.p.f.) of 8.4 and a total denier of 21,000. Alternatively, the tow can, for instance, have a denier per filament (d.p.f) of 9.5 and a total denier of 12,000. Alternatively, the tow can, for instance, have a denier per filament (d.p.f.) of 8 and a total denier of 15,000. In the present example, the tow comprises plasticized cellulose acetate tow. The plasticizer used in the tow comprises about 7% by weight of the tow. In the present example, the plasticizer is triacetin. In other examples, different materials can be used to form the body of material 15. For instance, rather than tow, the body 15 can be formed from paper, for instance in a similar way to paper filters known for use in cigarettes. Alternatively, the body 15 can be formed from tows other than cellulose acetate, for instance polylactic acid (PLA), other materials described herein for filamentary tow or similar materials. The tow can be formed from cellulose acetate. The tow, whether formed from cellulose acetate or other materials, can have a d.p.f. of at least 5, at least 6 or at least 7. These values of denier per filament provide a tow which has relatively coarse, thick fibers with a lower surface area which result in a lower pressure drop across the mouthpiece 2 than tows having lower d.p.f. values. To achieve a sufficiently uniform body of material 15, the tow can have a denier per filament of no more than 12 d.p.f, no more than 11 d.p.f. or no more than 10 d.p.f.

The total denier of the tow forming the body of material 15 can be at most 30,000, at most 28,000 or at most 25,000. These values of total denier provide a tow which takes up a reduced proportion of the cross sectional area of the article 10 which results in a lower pressure drop across the article 10 than tows having higher total denier values. For appropriate firmness of the body of material 15, the tow can have a total denier of at least 8,000 or at least 10,000. The denier per filament can be between 5 and 12 while the total denier is between 10,000 and 25,000. The denier per filament can be between 6 and 10 while the total denier is between 11,000 and 22,000. The cross-sectional shape of the filaments of tow can be ‘Y’ shaped, although in other embodiments other shapes such as ‘X’ shaped or ‘O’ shaped filaments can be used, with the same d.p.f. and total denier values as provided herein. The tow may comprise filaments having a cross-section with an isoperimetric ratio of 25 or less, 20 or less, or 15 or less. In some examples, the body of material may comprise an adsorbent material (e.g. charcoal) dispersed within the tow.

In some examples, the body of material 15 may comprise a capsule disposed within the body of material. The capsule can comprise a breakable capsule, for instance a capsule which has a solid, frangible shell surrounding a liquid payload. In some examples, a single capsule is used. The capsule is entirely embedded within the body of material. In other words, the capsule is completely surrounded by the material forming the body. In other examples, a plurality of breakable capsules may be disposed within the body of material, for instance 2, 3 or more breakable capsules. The length of the body of material can be increased to accommodate the number of capsules required. In examples where a plurality of capsules is used, the individual capsules may be the same as each other, or may differ from one another in terms of size and/or capsule payload. In other examples, multiple bodies of material may be provided, with each body containing one or more capsules.

In some embodiments, the body of material comprises first and second capsules. In such embodiments, the first capsule is disposed in a first portion of the body of material and the second capsule is disposed in a second portion of the body of material downstream of the first portion. In other embodiments, the article comprises two bodies of material, wherein the first and second capsules are disposed in the first and second bodies respectively.

The first capsule is heated to a first temperature during use and the second capsule is heated to a second temperature during use, wherein the second temperature is at least 4 degrees Celsius lower than the first temperature. The second temperature can be at least 5, 6, 7, 8, 9 or 10 degrees Celsius lower than the first temperature.

In some embodiments, the second capsule is spaced from the first capsule by a distance of at least 7 mm, measured as the distance between the centers of the first and second capsules. The second capsule can be spaced from the first capsule by a distance of at least 8, 9 or 10 mm. Increasing the distance between the first and second capsules increases the temperature difference between the first and second temperatures.

The first capsule comprises an aerosol modifying agent. The second capsule comprises an aerosol modifying agent which may be the same or different as the aerosol modifying agent of the first capsule. In some embodiments, a user may selectively rupture the first and second capsules by applying an external force to the capsules in order to release the aerosol modifying agent from each capsule.

The aerosol-modifying agent of the second capsule is heated to a lower temperature than the aerosol-modifying agent of the first capsule due to the difference between the first and second temperatures. The aerosol-modifying agents of the first and second capsules can be selected based on this temperature difference. For instance, the first capsule may comprise a first aerosol modifying agent that has a lower vapor pressure than a second aerosol modifying agent of the second capsule. If the capsules were both heated to the same temperature, then the higher vapor pressure of the aerosol modifying agent of the second capsule would mean that a greater amount of the second aerosol modifying agent would be volatized relative to the aerosol modifying agent of the first capsule. However, since the second capsule is heated to a lower temperature, this effect is less pronounced such that a more even amount of the aerosol modifying agents of the first and second capsules are volatized upon breaking of the first and second capsules respectively.

In some embodiments, the first and second capsules have the same aerosol-modifying profiles, meaning that both capsules contain the same type of aerosol-modifying agent and in the same amount such that if both capsules were heated to the same temperature and broken then both capsules would cause the same modification of the aerosol. However, since the first capsule is heated to a higher temperature than the second capsule, more of the aerosol-modifying agent of the first capsule will be, for example, volatized compared to the modifying agent of the second capsule and thus will cause a more pronounced modification of the aerosol than the second capsule.

Therefore, despite both capsules being the same, which may make the aerosol modifying component easier and/or less expensive to manufacture, the user can decide whether to break the first capsule to cause a more pronounced modification of the aerosol, or the second capsule to cause a less pronounced modification of the aerosol, or both capsules to cause the greatest modification of the aerosol.

In some embodiments, the first and second capsules both comprise first and second aerosol modifying agents. The first aerosol modifying agent has a lower vapor pressure than the second aerosol modifying agent. Thus, when the second capsule is broken, a greater proportion of the second aerosol modifying agent will be vaporized relative to the first aerosol modifying agent in comparison to when the hotter first capsule is broken during use of the system to generate aerosol. Therefore, the same capsule can be used to generate different modifications of the aerosol based on the positon of the capsule in the first or second portion of the aerosol modifying component.

The one or more capsules may comprise a core-shell structure. In other words, the capsules comprise a shell encapsulating a liquid agent, for instance a flavorant or other agent, which can be any one of the flavorants or aerosol modifying agents described herein. The shell can be ruptured by a user to release the flavorant or other agent into the body of material. The first plug wrap 16 can comprise a barrier coating to make the material of the plug wrap substantially impermeable to the liquid payload of the capsule. Alternatively or in addition, the second plug wrap 17 and/or tipping paper 18 can comprise a barrier coating to make the material of that plug wrap and/or tipping paper substantially impermeable to the liquid payload of the capsule.

In some examples, the one or more capsules are spherical and have a diameter of about 3.5 mm. In other examples, other shapes and sizes of capsule can be used, e.g. capsules which have a diameter of 2.5 mm, 3 mm, 4 mm or 4.5 mm. The total weight of the one or more capsules may be in the range about 10 mg to about 50 mg.

It is known to generate, for a given tow specification (such as 8.4Y21000), a tow capability curve which represents the pressure drop through a length of rod formed using the tow, for each of a range of tow weights. Parameters such as the rod length and circumference, wrapper thickness and tow plasticizer level are specified, and these are combined with the tow specification to generate the tow capability curve, which gives an indication of the pressure drop which would be provided by different tow weights between the minimum and maximum weights achievable using standard filter rod forming machinery. Such tow capability curves can be calculated, for instance, using software available from tow suppliers. It has been found that it is particularly advantageous to use a body of material 15 which includes filamentary tow having a weight per mm of length of the body of material 15 which is between about 10% and about 30% of the range between the minimum and maximum weights of a tow capability curve generated for the filamentary tow. This can provide an acceptable balance between providing enough tow weight to avoid shrinkage after the body 15 has been formed, providing an acceptable pressure drop, while also assisting with capsule placement within the tow, for capsules of the sizes described herein.

In the present example, the body of material 15 and hollow tubular element 13 are combined using a second plug wrap 17 which is wrapped around both sections. The second plug wrap 17 can have a basis weight of less than 50 gsm, or between about 20 gsm and 45 gsm. The second plug wrap 17 can have a thickness of between 30 μm and 60 μm, or between 35 μm and 45 μm. The second plug wrap 17 can be a non-porous plug wrap having a permeability of less than 100 Coresta units, for instance less than 50 Coresta units. However, in alternative embodiments, the second plug wrap 17 can be a porous plug wrap, for instance having a permeability of greater than 200 Coresta units.

In the present example, the aerosol forming material added to the aerosol generating substrate 20 comprises 14% by weight of the aerosol generating substrate 11. The aerosol forming material can comprise at least 5% by weight of the aerosol generating substrate, or at least 10%. The aerosol forming material comprises less than 25% by weight of the aerosol generating substrate, or less than 20%, for instance between 10% and 20%, between 12% and 18% or between 13% and 16%.

In some examples, the article 10 may be configured such that there is a separation (i.e. a minimum distance) between a heater of the non-combustible aerosol provision device 100 and the hollow tubular element 13. This prevents heat from the heater from damaging the material forming the hollow tubular element.

The minimum distance between a heater of the non-combustible aerosol provision device 100 and the hollow tubular element 13 may be 3 mm or greater. In some examples, minimum distance between the heater of the non-combustible aerosol provision device 100 and the hollow tubular element 13 may be in the range 3 mm to 10 mm, for example 3 mm, 4 mm, 5 mm, 6 mm, 7 mm, 8 mm, 9 mm or 10 mm.

The separation between the heating element of the non-combustible aerosol provision device 100 and the hollow tubular element 13 may be achieved by, for example, adjusting the length of the aerosol generating material 11.

The aerosol generating material 11 can be provided as a cylindrical rod of aerosol generating material. Irrespective of the form of the aerosol generating material, it can have a length of about 10 mm to 100 mm. In some embodiments, the length of the aerosol generating material is in the range about 25 mm to 50 mm, in the range about 30 mm to 45 mm, or about 30 mm to 40 mm.

The volume of aerosol generating material 11 provided can vary from about 200 mm³ to about 4300 mm³, from about 500 mm³ to 1500 mm³, or from about 1000 mm³ to about 1300 mm³. The provision of these volumes of aerosol generating material, for instance from about 1000 mm³ to about 1300 mm³, has been advantageously shown to achieve a superior aerosol, having a greater visibility and sensory performance compared to that achieved with volumes selected from the lower end of the range.

The mass of aerosol generating material 11 provided can be greater than 200 mg, for instance from about 200 mg to 400 mg, from about 230 mg to 360 mg, or from about 250 mg to 360 mg. It has been advantageously found that providing a higher mass of aerosol generating material results in improved sensory performance compared to aerosol generated from a lower mass of tobacco material.

The aerosol generating material or substrate can be formed from tobacco material as described herein, which includes a tobacco component.

In the tobacco material described herein, the tobacco component can contain paper reconstituted tobacco. The tobacco component may also contain leaf tobacco, extruded tobacco, and/or bandcast tobacco.

The aerosol generating material 11 can comprise reconstituted tobacco material having a density of less than about 700 milligrams per cubic centimeter (mg/cc). Such tobacco material has been found to be particularly effective at providing an aerosol generating material which can be heated quickly to release an aerosol, as compared to denser materials. For instance, the inventors tested the properties of various aerosol generating materials, such as bandcast reconstituted tobacco material and paper reconstituted tobacco material, when heated. It was found that, for each given aerosol generating material, there is a particular zero heat flow temperature below which net heat flow is endothermic, in other words more heat enters the material than leaves the material, and above which net heat flow is exothermic, in other words more heat leaves the material than enters the material, while heat is applied to the material. Materials having a density less than 700 mg/cc had a lower zero heat flow temperature. Since a significant portion of the heat flow out of the material is via the formation of aerosol, having a lower zero heat flow temperature has a beneficial effect on the time it takes to first release aerosol from the aerosol generating material. For instance, aerosol generating materials having a density of less than 700 mg/cc were found to have a zero heat flow temperature of less than 164° C., as compared to materials with a density over 700 mg/cc, which had zero heat flow temperatures greater than 164° C.

The density of the aerosol generating material also has an impact on the speed at which heat conducts through the material, with lower densities, for instance those below 700 mg/cc, conducting heat more slowly through the material, and therefore enabling a more sustained release of aerosol.

The aerosol generating material 11 can comprise reconstituted tobacco material having a density of less than about 700 mg/cc, for instance paper reconstituted tobacco material. The aerosol generating material 20 can comprise reconstituted tobacco material having a density of less than about 600 mg/cc. Alternatively or in addition, the aerosol generating material 11 can comprise reconstituted tobacco material having a density of at least 350 mg/cc, which is considered to allow for a sufficient amount of heat conduction through the material.

The tobacco material may be provided in the form of cut rag tobacco. The cut rag tobacco can have a cut width of at least 15 cuts per inch (about 5.9 cuts per cm, equivalent to a cut width of about 1.7 mm). The cut rag tobacco can have a cut width of at least 18 cuts per inch (about 7.1 cuts per cm, equivalent to a cut width of about 1.4 mm), or at least 20 cuts per inch (about 7.9 cuts per cm, equivalent to a cut width of about 1.27 mm). In one example, the cut rag tobacco has a cut width of 22 cuts per inch (about 8.7 cuts per cm, equivalent to a cut width of about 1.15 mm). The cut rag tobacco can have a cut width at or below 40 cuts per inch (about 15.7 cuts per cm, equivalent to a cut width of about 0.64 mm). Cut widths between 0.5 mm and 2.0 mm, for instance between 0.6 mm and 1.5 mm, or between 0.6 mm and 1.7 mm have been found to result in tobacco material which is advantageous in terms of surface area to volume ratio, particularly when heated, and the overall density and pressure drop of the substrate 20. The cut rag tobacco can be formed from a mixture of forms of tobacco material, for instance a mixture of one or more of paper reconstituted tobacco, leaf tobacco, extruded tobacco and bandcast tobacco. The tobacco material can comprise paper reconstituted tobacco or a mixture of paper reconstituted tobacco and leaf tobacco.

In the tobacco material described herein, the tobacco material may contain a filler component. The filler component is generally a non-tobacco component, that is, a component that does not include ingredients originating from tobacco. The filler component may be a non-tobacco fiber such as wood fiber or pulp or wheat fiber. The filler component may also be an inorganic material such as chalk, perlite, vermiculite, diatomaceous earth, colloidal silica, magnesium oxide, magnesium sulfate, magnesium carbonate. The filler component may also be a non-tobacco cast material or a non-tobacco extruded material. The filler component may be present in an amount of 0 to 20% by weight of the tobacco material, or in an amount of from 1 to 10% by weight of the composition. In some embodiments, the filler component is absent.

In the tobacco material described herein, the tobacco material contains an aerosol forming material. In this context, an “aerosol forming material” is an agent that promotes the generation of an aerosol. An aerosol forming material may promote the generation of an aerosol by promoting an initial vaporization and/or the condensation of a gas to an inhalable solid and/or liquid aerosol. In some embodiments, an aerosol forming material may improve the delivery of flavor from the aerosol generating material. In general, any suitable aerosol forming material or agents may be included in the aerosol generating material of the disclosure, including those described herein. Other suitable aerosol forming materials include, but are not limited to: a polyol such as sorbitol, glycerol, and glycols like propylene glycol or triethylene glycol; a non-polyol such as monohydric alcohols, high boiling point hydrocarbons, acids such as lactic acid, glycerol derivatives, esters such as diacetin, triacetin, triethylene glycol diacetate, triethyl citrate or myristates including ethyl myristate and isopropyl myristate and aliphatic carboxylic acid esters such as methyl stearate, dimethyl dodecanedioate and dimethyl tetradecanedioate. In some embodiments, the aerosol forming material may be glycerol, propylene glycol, or a mixture of glycerol and propylene glycol. The total amount of glycerol, propylene glycol, or a mixture of glycerol and propylene glycol used may be in the range of between 10% and 30%, for instance between 15% and 25% of the tobacco material measured on a dry weight basis. Glycerol may be present in an amount of from 10 to 20% by weight of the tobacco material, for example 13 to 16% by weight of the composition, or about 14% or 15% by weight of the composition. Propylene glycol, if present, may be present in an amount of from 0.1 to 0.3% by weight of the composition.

The aerosol forming material may be included in any component, for example any tobacco component, of the tobacco material, and/or in the filler component, if present. Alternatively or additionally the aerosol forming material may be added to the tobacco material separately. In either case, the total amount of the aerosol forming material in the tobacco material can be as defined herein.

The tobacco material can contain between 10% and 90% by weight tobacco leaf, wherein the aerosol forming material is provided in an amount of up to about 10% by weight of the leaf tobacco. To achieve an overall level of aerosol forming material between 10% and 20% by weight of the tobacco material, it has been advantageously found that this can be added in higher weight percentages to the another component of the tobacco material, such as reconstituted tobacco material.

The tobacco material described herein contains nicotine. The nicotine content is from 0.5 to 1.75% by weight of the tobacco material, and may be, for example, from 0.8 to 1.5% by weight of the tobacco material. Additionally or alternatively, the tobacco material contains between 10% and 90% by weight tobacco leaf having a nicotine content of greater than 1.5% by weight of the tobacco leaf. It has been advantageously found that using a tobacco leaf with nicotine content higher than 1.5% in combination with a lower nicotine base material, such as paper reconstituted tobacco, provides a tobacco material with an appropriate nicotine level but better sensory performance than the use of paper reconstituted tobacco alone. The tobacco leaf, for instance cut rag tobacco, can, for instance, have a nicotine content of between 1.5% and 5% by weight of the tobacco leaf.

The tobacco material described herein can contain an aerosol modifying agent, such as any of the flavors described herein. In one embodiment, the tobacco material contains menthol, forming a mentholated article. The tobacco material can comprise from 3 mg to 20 mg of menthol, between 5 mg and 18 mg or between 8 mg and 16 mg of menthol. In the present example, the tobacco material comprises 16 mg of menthol. The tobacco material can contain between 2% and 8% by weight of menthol, or between 3% and 7% by weight of menthol or between 4% and 5.5% by weight of menthol. In one embodiment, the tobacco material includes 4.7% by weight of menthol. Such high levels of menthol loading can be achieved using a high percentage of reconstituted tobacco material, for instance greater than 50% of the tobacco material by weight. Alternatively or additionally, the use of a high volume of aerosol generating material, for instance tobacco material, can increase the level of menthol loading that can be achieved, for instance where greater than about 500 mm³ or suitably more than about 1000 mm³ of aerosol generating material, such as tobacco material, are used.

In the compositions described herein, where amounts are given in % by weight, for the avoidance of doubt this refers to a dry weight basis, unless specifically indicated to the contrary. Thus, any water that may be present in the tobacco material, or in any component thereof, is entirely disregarded for the purposes of the determination of the weight %. The water content of the tobacco material described herein may vary and may be, for example, from 5 to 15% by weight. The water content of the tobacco material described herein may vary according to, for example, the temperature, pressure and humidity conditions at which the compositions are maintained. The water content can be determined by Karl-Fisher analysis, as known to those skilled in the art. On the other hand, for the avoidance of doubt, even when the aerosol forming material is a component that is in liquid phase, such as glycerol or propylene glycol, any component other than water is included in the weight of the tobacco material. However, when the aerosol forming material is provided in the tobacco component of the tobacco material, or in the filler component (if present) of the tobacco material, instead of or in addition to being added separately to the tobacco material, the aerosol forming material is not included in the weight of the tobacco component or filler component, but is included in the weight of the “aerosol forming material” in the weight % as defined herein. All other ingredients present in the tobacco component are included in the weight of the tobacco component, even if of non-tobacco origin (for example non-tobacco fibers in the case of paper reconstituted tobacco).

In an embodiment, the tobacco material comprises the tobacco component as defined herein and the aerosol forming material as defined herein. In an embodiment, the tobacco material consists essentially of the tobacco component as defined herein and the aerosol forming material as defined herein. In an embodiment, the tobacco material consists of the tobacco component as defined herein and the aerosol forming material as defined herein.

Paper reconstituted tobacco is present in the tobacco component of the tobacco material described herein in an amount of from 10% to 100% by weight of the tobacco component. In embodiments, the paper reconstituted tobacco is present in an amount of from 10% to 80% by weight, or 20% to 70% by weight, of the tobacco component. In a further embodiment, the tobacco component consists essentially of, or consists of, paper reconstituted tobacco. In some embodiments, leaf tobacco is present in the tobacco component of the tobacco material in an amount of from at least 10% by weight of the tobacco component. For instance, leaf tobacco can be present in an amount of at least 10% by weight of the tobacco component, while the remainder of the tobacco component comprises paper reconstituted tobacco, bandcast reconstituted tobacco, or a combination of bandcast reconstituted tobacco and another form of tobacco such as tobacco granules.

Paper reconstituted tobacco refers to tobacco material formed by a process in which tobacco feedstock is extracted with a solvent to afford an extract of solubles and a residue comprising fibrous material, and then the extract (usually after concentration, and optionally after further processing) is recombined with fibrous material from the residue (usually after refining of the fibrous material, and optionally with the addition of a portion of non-tobacco fibers) by deposition of the extract onto the fibrous material. The process of recombination resembles the process for making paper.

The paper reconstituted tobacco may be any type of paper reconstituted tobacco that is known in the art. In a particular embodiment, the paper reconstituted tobacco is made from a feedstock comprising one or more of tobacco strips, tobacco stems, and whole leaf tobacco. In a further embodiment, the paper reconstituted tobacco is made from a feedstock consisting of tobacco strips and/or whole leaf tobacco, and tobacco stems. However, in other embodiments, scraps, fines and winnowings can alternatively or additionally be employed in the feedstock.

The paper reconstituted tobacco for use in the tobacco material described herein may be prepared by methods which are known to those skilled in the art for preparing paper reconstituted tobacco.

A non-combustible aerosol provision device is used to heat the aerosol generating material 11 of the article 10. The non-combustible aerosol provision device can comprise a coil, since this has been found to enable improved heat transfer to the article 10 as compared to other arrangements.

In some examples, the coil is configured to, in use, cause heating of at least one electrically-conductive heating element, so that heat energy is conductible from the at least one electrically-conductive heating element to the aerosol generating material to thereby cause heating of the aerosol generating material.

In some examples, the coil is configured to generate, in use, a varying magnetic field for penetrating at least one heating element, to thereby cause induction heating and/or magnetic hysteresis heating of the at least one heating element. In such an arrangement, the or each heating element may be termed a “susceptor” as defined herein. A coil that is configured to generate, in use, a varying magnetic field for penetrating at least one electrically-conductive heating element, to thereby cause induction heating of the at least one electrically-conductive heating element, may be termed an “induction coil” or “inductor coil”.

The device may include the heating element(s), for example electrically-conductive heating element(s), and the heating element(s) may be suitably located or locatable relative to the coil to enable such heating of the heating element(s). The heating element(s) may be in a fixed position relative to the coil. Alternatively, the at least one heating element, for example at least one electrically-conductive heating element, may be included in the article 10 for insertion into a heating zone of the device, wherein the article 10 also comprises the aerosol generating material 11 and is removable from the heating zone after use. Alternatively, both the device and such an article 10 may comprise at least one respective heating element, for example at least one electrically-conductive heating element, and the coil may be to cause heating of the heating element(s) of each of the device and the article when the article is in the heating zone.

In some examples, the coil is helical. In some examples, the coil encircles at least a part of a heating zone of the device that is configured to receive aerosol generating material. In some examples, the coil is a helical coil that encircles at least a part of the heating zone.

In some examples, the device comprises an electrically-conductive heating element that at least partially surrounds the heating zone, and the coil is a helical coil that encircles at least a part of the electrically-conductive heating element. In some examples, the electrically-conductive heating element is tubular. In some examples, the coil is an inductor coil.

In some examples, the use of a coil enables the non-combustible aerosol provision device to reach operational temperature more quickly than a non-coil aerosol provision device. For instance, the non-combustible aerosol provision device including a coil as described above can reach an operational temperature such that a first puff can be provided in less than 30 seconds from initiation of a device heating program, or in less than 25 seconds. In some examples, the device can reach an operational temperature in about 20 seconds from the initiation of a device heating program.

The use of a coil as described herein in the device to cause heating of the aerosol generating material has been found to enhance the aerosol which is produced. For instance, consumers have reported that the aerosol generated by a device including a coil such as that described herein is sensorially closer to that generated in factory made cigarette (FMC) products than the aerosol produced by other non-combustible aerosol provision systems. Without wishing to be bound by theory, it is hypothesized that this is the result of the reduced time to reach the required heating temperature when the coil is used, the higher heating temperatures achievable when the coil is used and/or the fact that the coil enables such systems to simultaneously heat a relatively large volume of aerosol generating material, resulting in aerosol temperatures resembling FMC aerosol temperatures. In FMC products, the burning coal generates a hot aerosol which heats tobacco in the tobacco rod behind the coal, as the aerosol is drawn through the rod. This hot aerosol is understood to release flavor compounds from tobacco in the rod behind the burning coal. A device including a coil as described herein is thought to also be capable of heating aerosol generating material, such as tobacco material described herein, to release flavor compounds, resulting in an aerosol which has been reported to more closely resemble an FMC aerosol.

Using an aerosol provision system including a coil as described herein, for instance an induction coil which heats at least some of the aerosol generating material to at least 200° C., or at least 220° C., can enable the generation of an aerosol from an aerosol generating material that has particular characteristics which are thought to more closely resemble those of an FMC product. For example, when heating an aerosol generating material, including nicotine, using an induction heater, heated to at least 250° C., for a two-second period, under an airflow of at least 1.50 L/m during the period, one or more of the following characteristics has been observed:
at least 10 μg of nicotine is aerosolized from the aerosol generating material;
the weight ratio in the generated aerosol, of aerosol forming material to nicotine is at least about 2.5:1, suitably at least 8.5:1;
at least 100 μg of the aerosol forming material can be aerosolized from the aerosol generating material;
the mean particle or droplet size in the generated aerosol is less than about 1000 nm; and
the aerosol density is at least 0.1 μg/cc.

In some cases, at least 10 μg of nicotine, suitably at least 30 μg or 40 μg of nicotine, is aerosolized from the aerosol generating material under an airflow of at least 1.50 L/m during the period. In some cases, less than about 200 μg, suitably less than about 150 μg or less than about 125 μg, of nicotine is aerosolized from the aerosol generating material under an airflow of at least 1.50 L/m during the period.

In some cases, the aerosol contains at least 100 μg of the aerosol forming material, suitably at least 200 μg, 500 μg or 1 mg of aerosol forming material is aerosolized from the aerosol generating material under an airflow of at least 1.50 L/m during the period. Suitably, the aerosol forming material may comprise or consist of glycerol.

As defined herein, the term “mean particle or droplet size” refers to the mean size of the solid or liquid components of an aerosol (i.e. the components suspended in a gas). Where the aerosol contains suspended liquid droplets and suspended solid particles, the term refers to the mean size of all components together.

In some cases, the mean particle or droplet size in the generated aerosol may be less than about 900 nm, 800 nm, 700, nm 600 nm, 500 nm, 450 nm or 400 nm. In some cases, the mean particle or droplet size may be more than about 25 nm, 50 nm or 100 nm.

In some cases, the aerosol density generated during the period is at least 0.1 μg/cc. In some cases, the aerosol density is at least 0.2 μg/cc, 0.3 μg/cc or 0.4 μg/cc. In some cases, the aerosol density is less than about 2.5 μg/cc, 2.0 μg/cc, 1.5 μg/cc or 1.0 μg/cc.

The non-combustible aerosol provision device can be arranged to heat the aerosol generating material 11 of the article 10, to a maximum temperature of at least 160° C. The non-combustible aerosol provision device is arranged to heat the aerosol forming material 11 of the article 10, to a maximum temperature of at least about 200° C., or at least about 220° C., or at least about 240° C., or at least about 270° C., at least once during the heating process followed by the non-combustible aerosol provision device.

Using an aerosol provision system including a coil as described herein, for instance an induction coil which heats at least some of the aerosol generating material to at least 200° C., or at least 220° C., can enable the generation of an aerosol from an aerosol generating material in an article 10 as described herein that has a higher temperature as the aerosol leaves the mouth end of the mouthpiece 1 than previous devices, contributing to the generation of an aerosol which is considered closer to an FMC product. For instance, the maximum aerosol temperature measured at the mouth-end of the article 10 can be greater than 50° C., greater than 55° C. or greater than 56° C. or 57° C. Additionally or alternatively, the maximum aerosol temperature measured at the mouth-end of the article 10 can be less than 62° C., less than 60° C. or less than 59° C. In some embodiments, the maximum aerosol temperature measured at the mouth-end of the article 10 can be between 50° C. and 62° C., or between 56° C. and 60° C.

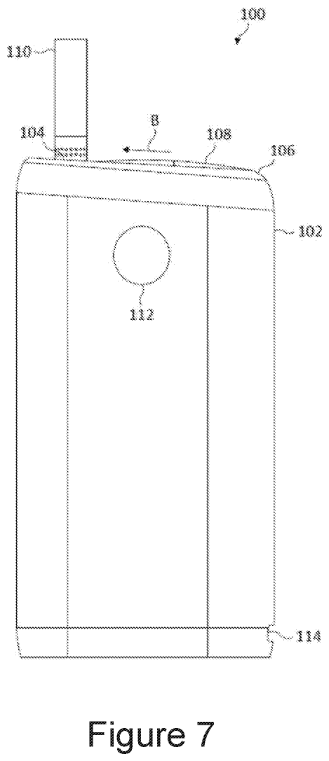

FIG. 7 shows an example of a non-combustible aerosol provision device 100 for generating aerosol from an aerosol generating medium/material such as the aerosol generating material 11 of the articles 10 described herein. In broad outline, the device 100 may be used to heat a replaceable article 110 comprising the aerosol generating medium, for instance the article described herein, to generate an aerosol or other inhalable medium which is inhaled by a user of the device 100. The device 100 and replaceable article 110 together form a non-combustible aerosol provision system.

The device 100 comprises a housing 102 (in the form of an outer cover) which surrounds and houses various components of the device 100. The device 100 has an opening 104 in one end, through which the article 110 may be inserted for heating by a heating assembly. In use, the article 110 may be fully or partially inserted into the heating assembly where it may be heated by one or more components of the heater assembly. When the article 110 is inserted into the device 100, the minimum distance between the one or more components of the heater assembly and a tubular element of the article 110 may be in the range 3 mm to 10 mm, for example 3 mm, 4 mm, 5 mm, 6 mm, 7 mm, 8 mm, 9 mm or 10 mm.

The device 100 of this example comprises a first end member 106 which comprises a lid 108 which is moveable relative to the first end member 106 to close the opening 104 when no article 110 is in place. In FIG. 7, the lid 108 is shown in an open configuration, however the lid 108 may move into a closed configuration. For example, a user may cause the lid 108 to slide in the direction of arrow “B”.

The device 100 may also include a user-operable control element 112, such as a button or switch, which operates the device 100 when pressed. For example, a user may turn on the device 100 by operating the switch 112.

The device 100 may also comprise an electrical component, such as a socket/port 114, which can receive a cable to charge a battery of the device 100. For example, the socket 114 may be a charging port, such as a USB charging port.

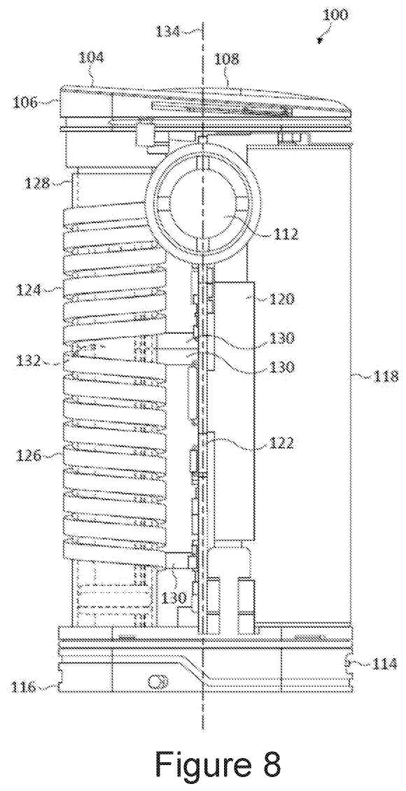

FIG. 8 depicts the device 100 of FIG. 7 with the outer cover 102 removed and without an article 110 present. The device 100 defines a longitudinal axis 134.

As shown in FIG. 8, the first end member 106 is arranged at one end of the device 100 and a second end member 116 is arranged at an opposite end of the device 100. The first and second end members 106, 116 together at least partially define end surfaces of the device 100. For example, the bottom surface of the second end member 116 at least partially defines a bottom surface of the device 100. Edges of the outer cover 102 may also define a portion of the end surfaces. In this example, the lid 108 also defines a portion of a top surface of the device 100.

The end of the device closest to the opening 104 may be known as the proximal end (or mouth end) of the device 100 because, in use, it is closest to the mouth of the user. In use, a user inserts an article 110 into the opening 104, operates the user control 112 to begin heating the aerosol generating material and draws on the aerosol generated in the device. This causes the aerosol to flow through the device 100 along a flow path towards the proximal end of the device 100.

The other end of the device furthest away from the opening 104 may be known as the distal end of the device 100 because, in use, it is the end furthest away from the mouth of the user. As a user draws on the aerosol generated in the device, the aerosol flows away from the distal end of the device 100.

The device 100 further comprises a power source 118. The power source 118 may be, for example, a battery, such as a rechargeable battery or a non-rechargeable battery. Examples of suitable batteries include, for example, a lithium battery (such as a lithium-ion battery), a nickel battery (such as a nickel-cadmium battery), and an alkaline battery. The battery is electrically coupled to the heating assembly to supply electrical power when required and under control of a controller (not shown) to heat the aerosol generating material. In this example, the battery is connected to a central support 120 which holds the battery 118 in place.

The device further comprises at least one electronics module 122. The electronics module 122 may comprise, for example, a printed circuit board (PCB). The PCB 122 may support at least one controller, such as a processor, and memory. The PCB 122 may also comprise one or more electrical tracks to electrically connect together various electronic components of the device 100. For example, the battery terminals may be electrically connected to the PCB 122 so that power can be distributed throughout the device 100. The socket 114 may also be electrically coupled to the battery via the electrical tracks.

In the example device 100, the heating assembly is an inductive heating assembly and comprises various components to heat the aerosol generating material of the article 110 via an inductive heating process. Induction heating is a process of heating an electrically conducting object (such as a susceptor) by electromagnetic induction. An induction heating assembly may comprise an inductive element, for example, one or more inductor coils, and a device for passing a varying electric current, such as an alternating electric current, through the inductive element. The varying electric current in the inductive element produces a varying magnetic field. The varying magnetic field penetrates a susceptor suitably positioned with respect to the inductive element, and generates eddy currents inside the susceptor. The susceptor has electrical resistance to the eddy currents, and hence the flow of the eddy currents against this resistance causes the susceptor to be heated by Joule heating. In cases where the susceptor comprises ferromagnetic material such as iron, nickel or cobalt, heat may also be generated by magnetic hysteresis losses in the susceptor, i.e. by the varying orientation of magnetic dipoles in the magnetic material as a result of their alignment with the varying magnetic field. In inductive heating, as compared to heating by conduction for example, heat is generated inside the susceptor, allowing for rapid heating. Further, there need not be any physical contact between the inductive heater and the susceptor, allowing for enhanced freedom in construction and application.

The induction heating assembly of the example device 100 comprises a susceptor arrangement 132 (herein referred to as “a susceptor”), a first inductor coil 124 and a second inductor coil 126. The first and second inductor coils 124, 126 are made from an electrically conducting material. In this example, the first and second inductor coils 124, 126 are made from Litz wire/cable which is wound in a helical fashion to provide helical inductor coils 124, 126. Litz wire comprises a plurality of individual wires which are individually insulated and are twisted together to form a single wire. Litz wires are designed to reduce the skin effect losses in a conductor. In the example device 100, the first and second inductor coils 124, 126 are made from copper Litz wire which has a rectangular cross section. In other examples the Litz wire can have other shape cross sections, such as circular.

The first inductor coil 124 is configured to generate a first varying magnetic field for heating a first section of the susceptor 132 and the second inductor coil 126 is configured to generate a second varying magnetic field for heating a second section of the susceptor 132. In this example, the first inductor coil 124 is adjacent to the second inductor coil 126 in a direction along the longitudinal axis 134 of the device 100 (that is, the first and second inductor coils 124, 126 to not overlap). The susceptor arrangement 132 may comprise a single susceptor, or two or more separate susceptors. Ends 130 of the first and second inductor coils 124, 126 can be connected to the PCB 122.

It will be appreciated that the first and second inductor coils 124, 126, in some examples, may have at least one characteristic different from each other. For example, the first inductor coil 124 may have at least one characteristic different from the second inductor coil 126. More specifically, in one example, the first inductor coil 124 may have a different value of inductance than the second inductor coil 126. In FIG. 8, the first and second inductor coils 124, 126 are of different lengths such that the first inductor coil 124 is wound over a smaller section of the susceptor 132 than the second inductor coil 126. Thus, the first inductor coil 124 may comprise a different number of turns than the second inductor coil 126 (assuming that the spacing between individual turns is substantially the same). In yet another example, the first inductor coil 124 may be made from a different material to the second inductor coil 126. In some examples, the first and second inductor coils 124, 126 may be substantially identical.

In this example, the first inductor coil 124 and the second inductor coil 126 are wound in opposite directions. This can be useful when the inductor coils are active at different times. For example, initially, the first inductor coil 124 may be operating to heat a first section/portion of the article 110, and at a later time, the second inductor coil 126 may be operating to heat a second section/portion of the article 110. Winding the coils in opposite directions helps reduce the current induced in the inactive coil when used in conjunction with a particular type of control circuit. In FIG. 8, the first inductor coil 124 is a right-hand helix and the second inductor coil 126 is a left-hand helix. However, in another embodiment, the inductor coils 124, 126 may be wound in the same direction, or the first inductor coil 124 may be a left-hand helix and the second inductor coil 126 may be a right-hand helix.

The susceptor 132 of this example is hollow and therefore defines a receptacle within which aerosol generating material is received. For example, the article 110 can be inserted into the susceptor 132. In this example the susceptor 120 is tubular, with a circular cross section.

The susceptor 132 may be made from one or more materials. The susceptor 132 comprises carbon steel having a coating of Nickel or Cobalt.

In some examples, the susceptor 132 may comprise at least two materials capable of being heated at two different frequencies for selective aerosolization of the at least two materials. For example, a first section of the susceptor 132 (which is heated by the first inductor coil 124) may comprise a first material, and a second section of the susceptor 132 which is heated by the second inductor coil 126 may comprise a second, different material. In another example, the first section may comprise first and second materials, where the first and second materials can be heated differently based upon operation of the first inductor coil 124. The first and second materials may be adjacent along an axis defined by the susceptor 132, or may form different layers within the susceptor 132. Similarly, the second section may comprise third and fourth materials, where the third and fourth materials can be heated differently based upon operation of the second inductor coil 126. The third and fourth materials may be adjacent along an axis defined by the susceptor 132, or may form different layers within the susceptor 132. Third material may the same as the first material, and the fourth material may be the same as the second material, for example. Alternatively, each of the materials may be different. The susceptor may comprise carbon steel or aluminum for example.

The device 100 of FIG. 8 further comprises an insulating member 128 which may be generally tubular and at least partially surround the susceptor 132. The insulating member 128 may be constructed from any insulating material, such as plastic for example. In this particular example, the insulating member is constructed from polyether ether ketone (PEEK). The insulating member 128 may help insulate the various components of the device 100 from the heat generated in the susceptor 132.

The insulating member 128 can also fully or partially support the first and second inductor coils 124, 126. For example, as shown in FIG. 8, the first and second inductor coils 124, 126 are positioned around the insulating member 128 and are in contact with a radially outward surface of the insulating member 128. In some examples the insulating member 128 does not abut the first and second inductor coils 124, 126. For example, a small gap may be present between the outer surface of the insulating member 128 and the inner surface of the first and second inductor coils 124, 126.

In a specific example, the susceptor 132, the insulating member 128, and the first and second inductor coils 124, 126 are coaxial around a central longitudinal axis of the susceptor 132.

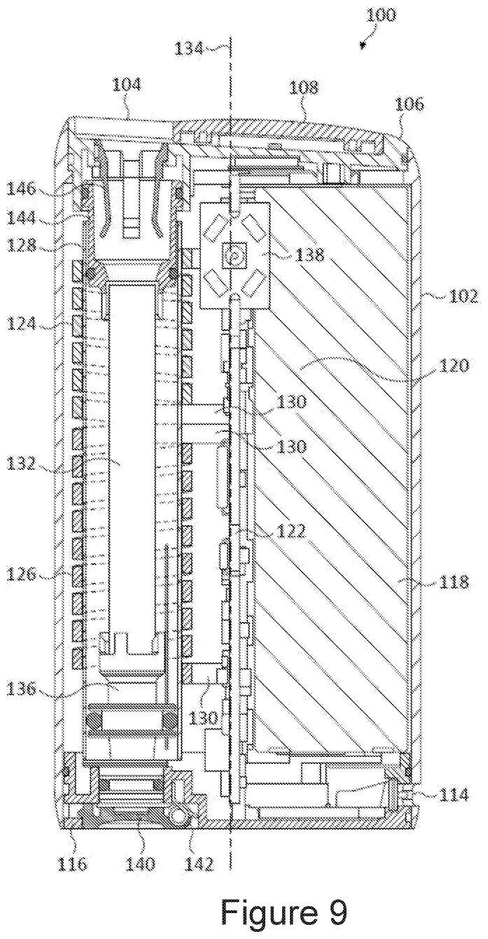

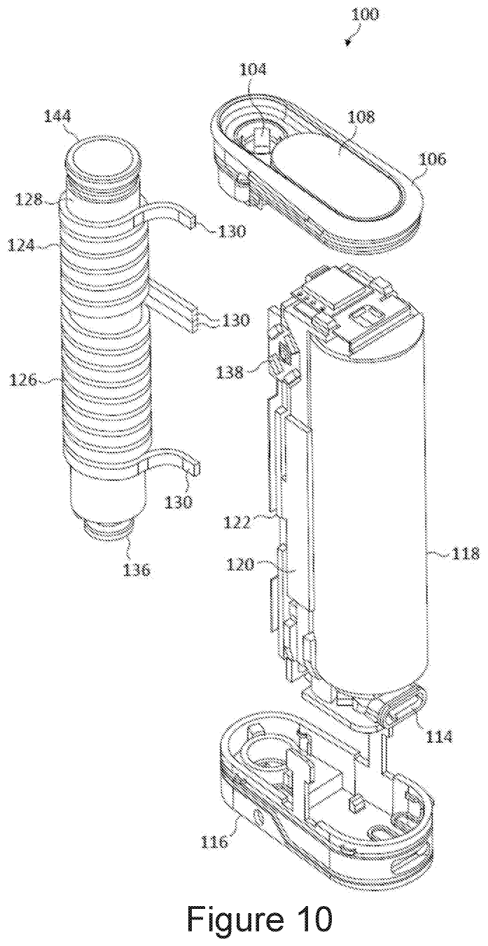

FIG. 9 shows a side view of device 100 in partial cross-section. The outer cover 102 is present in this example. The rectangular cross-sectional shape of the first and second inductor coils 124, 126 is more clearly visible.

The device 100 further comprises a support 136 which engages one end of the susceptor 132 to hold the susceptor 132 in place. The support 136 is connected to the second end member 116.

The device may also comprise a second printed circuit board 138 associated within the control element 112.

The device 100 further comprises a second lid/cap 140 and a spring 142, arranged towards the distal end of the device 100. The spring 142 allows the second lid 140 to be opened, to provide access to the susceptor 132. A user may open the second lid 140 to clean the susceptor 132 and/or the support 136.

The device 100 further comprises an expansion chamber 144 which extends away from a proximal end of the susceptor 132 towards the opening 104 of the device. Located at least partially within the expansion chamber 144 is a retention clip 146 to abut and hold the article 110 when received within the device 100. The expansion chamber 144 is connected to the end member 106.

FIG. 10 is an exploded view of the device 100 of FIG. 9, with the outer cover 102 omitted.

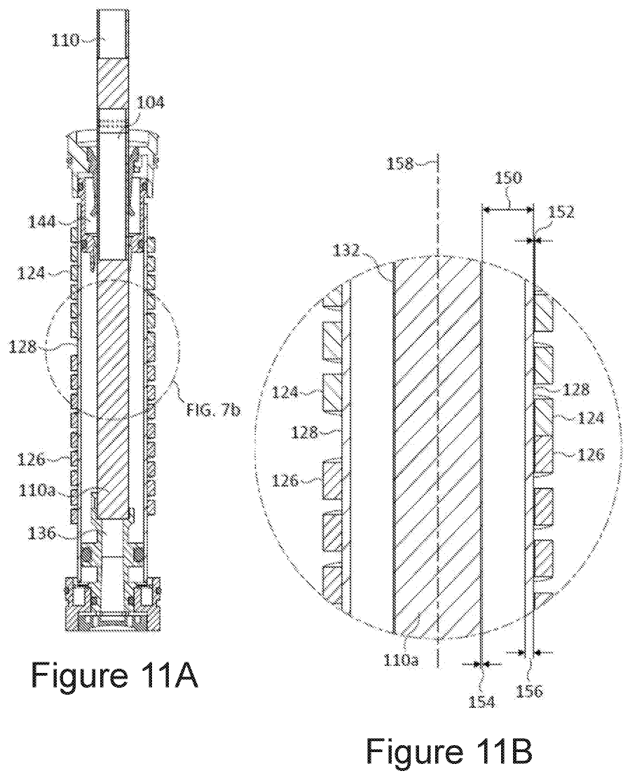

FIG. 11A depicts a cross section of a portion of the device 100 of FIG. 9. FIG. 11B depicts a close-up of a region of FIG. 11A. FIGS. 11A and 11B show the article 110 received within the susceptor 132, where the article 110 is dimensioned so that the outer surface of the article 110 abuts the inner surface of the susceptor 132. This ensures that the heating is most efficient. The article 110 of this example comprises aerosol generating material 110a. The aerosol generating material 110a is positioned within the susceptor 132. The article 110 may also comprise other components such as a filter, wrapping materials and/or a cooling structure.

FIG. 11B shows that the outer surface of the susceptor 132 is spaced apart from the inner surface of the inductor coils 124, 126 by a distance 150, measured in a direction perpendicular to a longitudinal axis 158 of the susceptor 132. In one particular example, the distance 150 is about 3 mm to 4 mm, about 3-3.5 mm, or about 3.25 mm.

FIG. 11B further shows that the outer surface of the insulating member 128 is spaced apart from the inner surface of the inductor coils 124, 126 by a distance 152, measured in a direction perpendicular to a longitudinal axis 158 of the susceptor 132. In one particular example, the distance 152 is about 0.05 mm. In another example, the distance 152 is substantially 0 mm, such that the inductor coils 124, 126 abut and touch the insulating member 128.

In one example, the susceptor 132 has a wall thickness 154 of about 0.025 mm to 1 mm, or about 0.05 mm.

In one example, the susceptor 132 has a length of about 40 mm to 60 mm, about 40 mm to 45 mm, or about 44.5 mm.

In one example, the insulating member 128 has a wall thickness 156 of about 0.25 mm to 2 mm, 0.25 mm to 1 mm, or about 0.5 mm.

In use, the article 10 described herein can be inserted into a non-combustible aerosol provision device such as the device 100 described with reference to FIGS. 7 to 11. At least a portion of the mouthpiece 1 of the article 10 protrudes from the non-combustible aerosol provision device 100 and can be placed into a user's mouth. An aerosol is produced by heating the aerosol generating material 11 using the device 100. The aerosol produced by the aerosol generating material 11 passes through the mouthpiece 1 to the user's mouth.

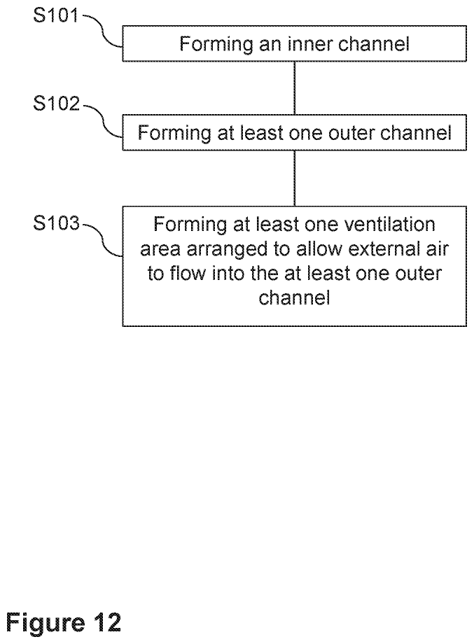

FIG. 12 is a flow chart showing a method of manufacturing a component for use in a non-combustible aerosol provision system.

The method comprises the following steps: forming an inner channel (S101); forming at least one outer channel (S102); and forming at least one ventilation area arranged to allow external air to flow into the at least one outer channel (S103).

In some examples, forming the inner channel and/or forming the at least one outer channel comprises an injection molding process.

In some examples, forming the inner channel comprises forming a tube from a corrugated sheet material. The method may comprise forming a plurality of outer channels, wherein forming the outer channels comprises wrapping a planar sheet of material around the tube.

In some examples, forming the at least one ventilation area comprises forming an aperture in a material.

The various embodiments described herein are presented only to assist in understanding and teaching the disclosed features. These embodiments are provided as a representative sample of embodiments only, and are not exhaustive and/or exclusive. It is to be understood that advantages, embodiments, examples, functions, features, structures, and/or other aspects described herein are not to be considered limitations on the scope of the disclosure, and that other embodiments may be utilized and modifications may be made without departing from the scope of the disclosure. Various embodiments of the disclosure may suitably comprise, consist of, or consist essentially of, appropriate combinations of the disclosed elements, components, features, parts, steps, means, etc, other than those specifically described herein. In addition, this disclosure may include other inventions not presently claimed, but which may be claimed in future.

1. A component for use in a non-combustible aerosol provision system, the component comprising:
an inner channel;
at least one outer channel; and
at least one ventilation area arranged to allow external air to flow into the at least one outer channel.

2. The component of claim 1, further comprising an inner wall separating the inner channel from the at least one outer channel, wherein the inner wall is substantially impermeable to air.

3. The component of claim 1, further comprising an outer wall, wherein the at least one ventilation area is formed in the outer wall.

4. The component of claim 3, wherein the at least one ventilation area comprises at least one ventilation aperture formed in the outer wall.

5. The component of claim 3, further comprising an end wall connecting the inner wall and the outer wall, the end wall defining a distal end of the at least one outer channel.

6. The component of claim 1, comprising a plurality of outer channels, each outer channel having at least one corresponding ventilation area.

7. The component of claim 6, further comprising one or more walls formed from a sheet material.

8. The component of claim 6, wherein the outer channels are arranged around the inner channel.

9. The component of claim 1, wherein the inner channel and the at least one outer channel are substantially parallel.

10. The component of claim 1, wherein the ratio of the cross sectional area of the at least one outer channel to the cross sectional area of the inner channel is in the range 5:1 to 0.5:1.

11. The component of claim 1, comprising a mouth end and a distal end, wherein the inner channel and the at least one outer channel are open at the mouth end.

12. The component of claim 11, further comprising an opening at the distal end of the component, wherein the opening is arranged to receive a rod-shaped article.

13. An article for use with a non-combustible aerosol provision device, the article comprising:
an aerosol generating material comprising at least one aerosol forming material; and
a component an inner channel, at least one outer channel and at least one ventilation area arranged to allow external air to flow into the at least one outer channel.

14. The article of claim 13, further comprising a tubular section disposed downstream of the aerosol generating material.

15. The article of claim 14, wherein the tubular section has a wall thickness between 0.5 mm and 2.5 mm.

16. The article of claim 14, wherein the tubular section has a length of at least 10 mm.

17. The article of claim 14, wherein the tubular section comprises a wall comprising an aerosol generating material.

18. The article of claim 14, wherein the tubular section comprises paper having a thickness greater than 325 microns and/or a wall having a permeability of at least 100 Coresta Units.

19. The article of claim 14, further comprising a ventilation area arranged to allow external air to flow into the tubular section.

20. The article of claim 19, wherein said ventilation area comprises a single row of ventilation apertures.

21. The article of claim 19, wherein said ventilation area comprises two or more rows of ventilation apertures.

22. The article of claim 19, wherein the aerosol generating material is wrapped by a wrapper having a level of permeability greater than about 1000 Coresta Units, or about 2000 Coresta Units.

23. The article of claim 18, wherein the level of ventilation provided by said ventilation area is within the range of 45% to 65% of the volume of aerosol generated by said non-combustible aerosol provision device passing through the article, or within the range of 40% to 60% of the volume of aerosol generated by said non-combustible aerosol provision device passing through the article.

24. The article of claim 13, further comprising a body of material disposed downstream of the aerosol generating material.

25. The article of claim 24, wherein the body of material comprises filamentary tow.

26. The article of claim 25, wherein the filamentary tow comprises filaments having a cross-section with an isoperimetric ratio of 25 or less, 20 or less, or 15 or less.

27. The article of claim 25, wherein the filamentary tow comprises a weight per mm of length of the body of material which is between about 10% and about 30% of the range between the minimum and maximum weights of a tow capability curve generated for the filamentary tow.

28. The article of claim 13, further comprising an adsorbent material.

29. The article of claim 13, further comprising a wrapper.

30. The article of claim 29, wherein the wrapper has a citrate content of 2% by weight or less, or 1% by weight or less.

31. The article of claim 13, wherein the article is configured such that when the article is inserted into the non-combustible aerosol provision device, the minimum distance between a heater of the non-combustible aerosol provision device and the tubular section of the article is at least about 3 mm.

32. A method of manufacturing a component for use in a non-combustible aerosol provision system, the method comprising:
forming an inner channel;
forming at least one outer channel; and
forming at least one ventilation area arranged to allow external air to flow into the at least one outer channel.

33. The method of claim 32, wherein forming the inner channel and/or forming the at least one outer channel comprises an injection molding process.

34. The article of claim 32, wherein forming the inner channel comprises forming a tube from a corrugated sheet material.

35. The article of claim 34, comprising forming a plurality of outer channels, wherein forming the outer channels comprises wrapping a planar sheet of material around the tube.

36. The method of claim 32, wherein forming the at least one ventilation area comprises forming an aperture in a material.
